(19) United States
(12) Patent Application Publication
(10) Pub. No.: US 2008/0154637 A1
(43) Pub. Date: Jun. 26, 2008

(54) METHODS FOR RISK-ADJUSTED PERFORMANCE ANALYSIS

(76) Inventors: Christopher C. Capelli, Houston, TX (US); William T. Little, Houston, TX (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/955,287

(22) Filed: Dec. 12, 2007

Related U.S. Application Data
(60) Provisional application No. 60/876,675, filed on Dec. 22, 2006.

(51) Int. Cl. G06Q 50/00; G06Q 10/00

(52) U.S. Cl. 705/2; 705/7

(57) ABSTRACT

The present invention provides systems and methods for risk-adjusted performance analysis for a specific healthcare test, market or opportunity by evaluating patient outcomes against a real-time benchmark portfolio of patient outcomes. The risk-adjusted performance measures are based on financial methods such as CAPM, single-index model and arbitrage pricing theory methods. In place of examining the financial returns for a portfolio of companies against a financial benchmark, the outcomes for a patient or a portfolio of patients is compared to a benchmark portfolio of patient outcomes. The risk-adjusted performance measures including the Sharpe's measure, Treynor's measure, Jensen's measure and similar analysis tools are then used to compare different healthcare groups. The method has utility in many areas of healthcare including management of healthcare facilities, providing insurance reimbursement to a healthcare facility (e.g., “pay-for-performance”), making investment decisions in the healthcare marketplace and developing dynamic prognostic dynamic medical tests.

### CROSS-REFERENCE TO RELATED APPLICATIONS

This application claims priority to U.S. Provisional Patent Application No. 60/876,675, filed Dec. 22, 2006, the contents of which is incorporated herein by reference in its entirety.

### FIELD OF THE INVENTION

The present invention relates generally to providing risk-adjusted performance measurements for comparing various healthcare groups and opportunities and, in particular, to methods for determining and comparing different performance criteria as well as determining successful and not successful outcomes.

### BACKGROUND OF THE INVENTION

Healthcare continues to evolve from single community hospitals to major hospital systems consisting of multiple hospitals and clinics in extended geographical locations. As the major hospital systems expand there is a need to provide a consistent level of quality care in the major hospital system's remote healthcare facilities. To provide a consistent level of quality care, healthcare institutions are developing performance measurements.

Current methods for performance measurement utilize chart review, complication rates, financial returns, etc. These methods are not adequate because the resources needed to collect the specific data, or the relevancy of the specific data, does not provide an adequate measure of performance and therefore quality of care. Furthermore, due to the different compositions of patients seen at different sites, it is difficult to provide a comparison, and therefore a performance evaluation, between healthcare groups such as remote healthcare facilities in a major hospital system to the major hospital system.

Because of these difficulties, the healthcare industry is moving toward measuring performance based on outcomes. Until recently, using outcomes to measure performance has been difficult because the outcomes for treating a patient group with the same illness using the same therapy may be significantly different because of the specific risk factors of the patients in the patient group. These specific risks factors can include a large number of items including age, where the patient lives, weight, height, marital status, other diseases, etc.

A standard approach to measuring performance based on outcomes is to compare the outcome of a patient with the “expected outcome” for that patient for a specific illness. The expected outcome is the outcome that has been risk-adjusted to the patient's specific risk factors including age, where the patient lives, weight, height, marital status, other diseases, etc.

FIG. 1 (prior art) is a flowchart that illustrates a conventional prior art method of deriving the expected outcome. Step 1 in the method involves establishing a database consisting of historical data of patients having the same illness(es). For example, a database can consist of outcomes for patients with breast cancer. This historical database is populated with specific risk factors (i.e., F1, F2, F3, etc.) for each patient in the database. These specific risks factors can include items such as age, geographical location, weight, height, marital status, co-morbidities, etc.

With further reference to FIG. 1, step 2 uses the historical database to derive a linear regression equation:

Expected (Outcome)=α+β₁F1+β₂F2+βᵢRFᵢ+ . . . .

The derived coefficients (α, β₁, β₂, βᵢ) relate the expected outcome for the specific illness to specific risks factors F1, F2, F3, etc. These derived coefficients are based solely on the specific risks factors that are in the database. Once the historical database has been established and the linear regression equation has been derived, the expected outcome for any new patient with the specific illness can be calculated. To use this equation, specific risk factors (F1, F2, F3, . . . Fi) for the patient of interest are obtained. These risk factors are then used in the derived linear regression equation above to calculate the expected outcome.

To measure the performance for treating this patient, the expected outcome and the actual outcome are compared. If the actual outcome is better than the calculated expected outcome, the performance is good. Likewise, if the actual outcome is worse than the calculated expected outcome, the performance is poor.

When measuring the performance of a healthcare system such as a hospital, clinic, doctors' group, etc., consisting of a group or “portfolio” of patients, the average differences between all expected outcomes and all actual outcomes is compared. If the difference between the average actual outcomes is better than the average expected outcomes, the healthcare system performance is good. Likewise, if the difference between the average actual outcomes is worse than the average expected outcomes, the healthcare system performance is poor.

There are a number of drawbacks associated with using the above-identified method for measuring performance for a healthcare system. First, the expected outcome is calculated using linear regression techniques based on historical patient data built around patient specific risk factors (e.g., smoking, co-morbidities, socioeconomic factors, etc.). This is a major problem because it requires a substantial amount of resources (e.g., time, labor, expenses, etc.) to gather the information and input the specific risk factors into a database. Furthermore, keeping the historical database up to date is difficult if not impossible. Finally, missing information, or poor information, pertaining to the patient's specific risk factors affects the quality of the historical patient database. As a result, the use of patient specific risk factors to build a historical database to derive a linear regression equation for use in calculating expected outcome is less than ideal.

Another drawback associated with using historical data based on patient specific risk factors is that the linear regression coefficients used to calculate the expected outcome become irrelevant over time due to changes in therapy or treatments that improve the outcomes of the patient. For example, a patient who has been diagnosed with Stage 4 breast cancer may have an expected outcome—in terms of survival rate, calculated from the coefficients derived from the historical database—of 20% at year 2. Based on this expected outcome, her physician may consider conservative treatment.

However, assume that a new treatment is introduced which results in the survival rate for Stage 4 breast cancer at year 2 to increase to 80%. In this scenario, the linear regression coefficients derived from the historical database to calculate expected outcome would result in a expected survival rate that is wrong given the new therapy. As a result, given the new therapy, the linear regression equation used to calculate expected outcomes is inaccurate. Therefore, deriving a performance measure based on the difference between expected outcome and actual outcome is not possible.

For the conventional approach to be useful, a database based on the new outcome data using the improved therapy would need to be assembled and new linear regression coefficients be derived. These new coefficients can then be used to calculate expected outcomes for use in measuring performance given the new therapy. Unfortunately, this undertaking is labor intensive and expensive.

### SUMMARY OF THE INVENTION

The present invention provides methods for risk-adjusted performance analysis. Methods are disclosed for measuring performance for a healthcare system that is less dependent on patient specific risk factors. In addition methods are disclosed for providing real-time performance measures that can be used to evaluate different healthcare opportunities.

One embodiment of the invention involves a method for comparing healthcare outcomes that have been risk-adjusted to a benchmark of real-time healthcare outcomes, comprising the steps of selecting an activity, selecting an outcome to use as a performance measure, determining a risk factor that has an association with the outcome, and analyzing the determined risk factor to use in risk-adjusting the outcome, wherein the healthcare outcomes are independent of patient specific risk factors.

The method may further comprise the step of determining the risk-adjusted performance measure, which may be applied: (i) to improve management of components of a healthcare system, (ii) to evaluate performance of a healthcare system, (iii) to provide life insurance products for individuals with significant illnesses, (iv) to make a decision on financial opportunities in healthcare, (v) for healthcare treatment planning, (vi) to analyze pay-for-performance measures of healthcare groups and individuals, and/or (vii) in medical prognostic testing.

The method may further comprise creating a database containing descriptive data and outcome data for the patients treated, wherein the outcome data for the database is continually updated. The descriptive data of patients treated may include data selected from the group consisting of diagnosis data, stage of diagnosis data, treatment data, and initial treatment data provided for the diagnosis. In addition, the performance measure may be risk-adjusted based on a financial portfolio theory risk-adjustment measures. By way of example, the financial portfolio theory risk adjustment measures may be selected from the group consisting of Sharpe's measure, Treynor's measure and Jensen's measure.

According to an embodiment of the invention, a method for determining risk factors for an outcome of an activity by comparing real-time healthcare outcomes that have been risk-adjusted for systematic risk to a benchmark of real-time healthcare outcomes, comprises the steps of: determining total risk of the activity, determining systematic risk and specific risk of the activity, and using systematic risk to risk-adjust outcomes.

According to a further embodiment of the invention, a method for providing performance measures for healthcare by comparing real-time healthcare outcomes in the healthcare market that have been risk-adjusted to a benchmark of real-time healthcare outcomes, comprises the steps of: (i) selecting an outcome to measure performance of the healthcare; (ii) establishing a benchmark portfolio from a benchmark facility and a patient portfolio from a healthcare market; (iii) performing linear regression between the outcomes from the patient portfolio and the outcomes from the benchmark portfolio; (iv) deriving linear regression factors, alpha and beta; (v) calculating risk-adjusted performance measures for the outcomes for the patient portfolio from the derived linear regression factors; and (vi) determining the calculated risk-adjusted performance measures to provide performance measures for the healthcare market.

Other embodiments of the invention feature a computer program stored on a computer readable medium for providing real-time risk-adjusted performance measures for healthcare, comprising: machine readable instructions for comparing the healthcare outcome with a benchmark of real-time healthcare outcome; and machine readable instructions for determining a risk-adjusted performance measure. The risk-adjusted performance measure may be based on a model selected from the group consisting of: a CAPM, a single index model, and an arbitrage pricing model, wherein the model is based on Sharpe's measure, Treynor's measure or Jensen's measure.

Yet another embodiment of the invention involves a computer program stored on a computer readable medium for comparing healthcare groups using risk-adjusted performance measures comprising: (i) machine readable instructions for selecting an outcome to measure a performance of a healthcare market; (ii) machine readable instructions for establishing a benchmark portfolio from a benchmark facility and a patient portfolio from a healthcare group; (iii) machine readable instructions for performing linear regression between the outcome from the patient portfolio and the outcome from the benchmark portfolio to derive linear regression factors alpha and beta; (iv) machine readable instructions for calculating risk-adjusted performance measures for the outcomes for the patient portfolio from the linear regression factors; and (v) machine readable instructions for calculating risk-adjusted performance measures to compare the healthcare groups. The computer program may further comprise machine readable instructions for determining an optimal treatment for a patient.

### BRIEF DESCRIPTION OF THE DRAWINGS

FIG. 1 (prior art) is a flowchart illustrating the current approach to performance measurement in healthcare.

FIG. 2 is a graph demonstrating diversification through an increase in the number of patients in a portfolio.

FIG. 3 is a summary table of outcome results based on accumulated days hospitalized for a Market Portfolio and a Patient Portfolio.

FIG. 4 is a summary table of outcome results based on death rate for a Market Portfolio and a Patient Portfolio.

FIG. 5 is a graph comparing the outcomes between the Market Portfolio and the Patient Portfolio in terms of accumulated days hospitalized.

FIG. 6 is a graph comparing the outcomes between the Market Portfolio and the Patient Portfolio in terms of death rate.

FIG. 7 is the graph comparing outcome results between the Remote Clinic and the Major Medical Center in terms of unadjusted death rate.

FIG. 8 is a comparison of breast cancer profile by stages between the Remote Clinic and the Major Medical Center.

FIG. 9 is the graph comparing outcome results between the Remote Clinic and the Major Medical Center in terms of risk-adjusted death rate.

FIG. 10 is a table showing details for the performance for ten MD oncology groups.

FIG. 11 is a table showing details for the risk-adjusted performance for ten MD oncology groups.

FIG. 12 is a bar graph illustrating the comparison of the performance for ten MD oncology groups.

FIG. 13 is a flowchart illustrating the process for developing and using a prognostic test using methods of this invention.

FIG. 14 is a table shown the summary of prognostic test results for month 24.

FIG. 15 is a chart depicting death rate versus cancer stage.

FIG. 16 is a chart depicting death rate versus Beta.

FIG. 17 is a table illustrating death rate and Beta for five cancers.

FIG. 18 is a chart depicting cross-sectional regression of five cancers.

FIG. 19 is a table illustrating regression statistics for five cancers.

FIG. 20 is a summary chart for the five cancers.

FIG. 21 is a flowchart illustrating an exemplary method for risk-adjusted performance in accordance with the principles of the invention.

FIG. 22 is a flowchart illustrating an exemplary method for determining risk factors for an outcome of an activity in accordance with the principles of the invention.

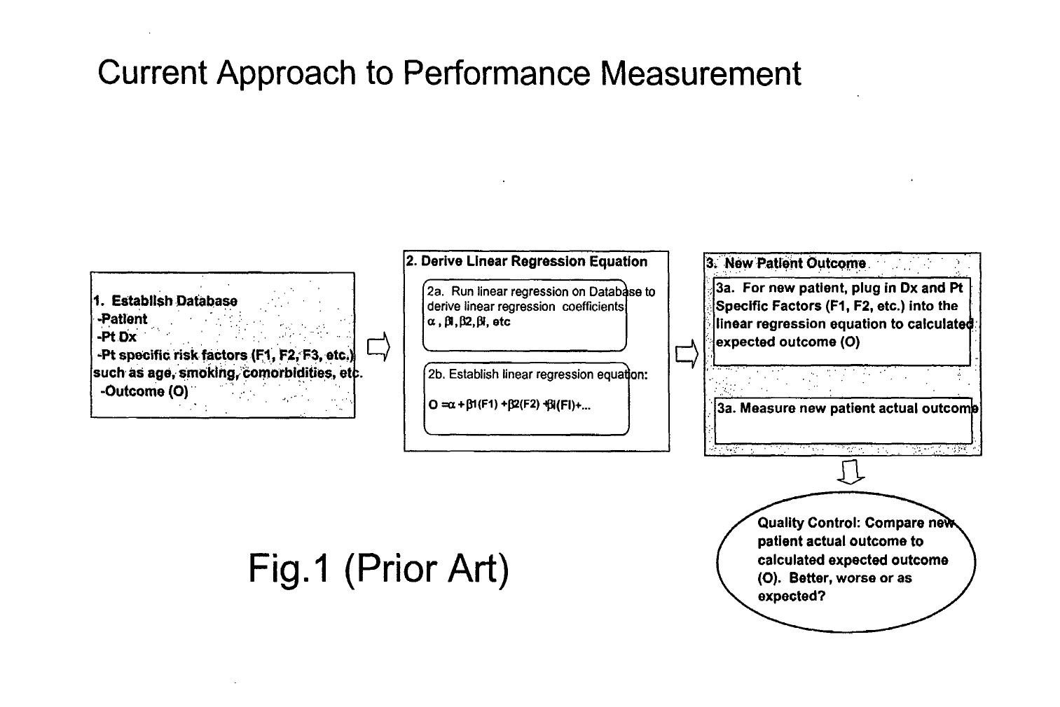

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Embodiments of the present invention may be described herein in terms of various functional blocks and processing steps. Such functional blocks may be realized by any number of hardware and/or software components configured to perform specified functions and achieve various results. For example, embodiments of the present invention may employ any desired machine, processor, integrated circuit component, interface, transmission media, integrated and/or distributed computer system, storage system, database, and the like, which may carry out any desired function under the control of one or more computers and/or other control devices. Additionally, the present invention may employ any number of conventional techniques for data storage and analysis, component interfacing, data processing, information conversion, communication, and the like. Furthermore, the present invention may be practiced in conjunction with any number of processes, systems, and/or devices.

Systems for risk-adjusted performance analysis, according to various aspects of the present invention, may be implemented in any suitable manner, such as one or more computer programs operating on one or more computer systems, which may include one or more processors and memory. The computer system may interface with any other computer, system, or device in any manner, such as over a local area network (LAN), the Internet, and the like.

Before starting a description of the Figures, some terms will now be defined.

Benchmark Portfolio is a portfolio for which a security or an asset is held in proportion to its market. It is a portfolio that may be used to reflect and represent the broad market. Benchmark portfolio is used interchangeably herein with the Market Portfolio.

Beta is a measure of systematic risk.

Diversifiable Risk is a risk attributable to specific risk or non-market risk.

Diversification means a spreading of a portfolio over multiple assets to avoid excessive exposure to any single source or risk.

Healthcare or Healthcare System refers to a healthcare institution, clinic, or a private physician or other establishment in the healthcare industry.

Market Portfolio is a portfolio for which each security or asset is held in proportion to its market. It is a portfolio that may be used to reflect and represent the broad market. Market portfolio is used interchangeably herein with the benchmark portfolio.

Market Risk or Systemic Risk is a risk attributable to common macroeconomic and/or macro-factors; e.g., risk factors that are common to the entire economy or disease state. Systematic risk is used interchangeably herein with market risk.

Non-diversifiable Risk refers to a systematic or market risk.

Non-systemic Risk is a risk that is unique to an individual asset or patient that can be eliminated by diversification. It represents the component of an asset's return or patient's outcome that is uncorrelated with a market or benchmark portfolio. Non-systematic risk is used interchangeably herein with specific risk.

Patient Portfolio is a collection or group of patients treated by a healthcare institution, clinic, or a private physician (collectively “healthcare system”).

Real-Time refers to a database, information, etc. that is updated on a periodic basis. This periodic basis can be has long as one year and as short as one a fraction of a second.

Systematic Risk is a risk attributable to common macroeconomic or macro-health actors (e.g., risk factors that are common to the entire economy or disease state). Systematic risk is used interchangeably herein with market risk.

Specific Risk is a risk that is unique to an individual asset or patient and independent of market risks. It represents the component of an asset's return or patient's outcome that is uncorrelated with the market or benchmark portfolio. Specific risk is used interchangeably herein with non-systematic risk.

### Healthcare Outcomes Performance Measurements

Certain activities and/or medical conditions have “inherent risk”. These inherent risks have a mean-variance relationship with specific outcomes. Inherent risk is the risk associated with a specific condition or activity. For example, sports activities for which the outcome being defined is death, the inherent risk of death from walking versus biking versus mountain climbing increases. In medicine, medical conditions such as cancers, heart disease, liver disease, kidney disease, etc. have inherent risk associated with specific outcomes suck as death. In these activities and medical conditions, the greater the inherent risk the more likely the specific outcome. For example, more aggressive cancers have a higher death rate than other less aggressive cancers. Lung cancer has a higher death rate that breast cancer. Likewise, higher staged cancers have higher death rate than lower staged cancers.

An individual who undertakes certain activities or has a medical condition has a total risk associated with the certain activity or medical condition that is made up of the following:

Total risk=systematic risk+specific risk.

Wherein,

Systematic risk=inherent risk+macro factors; and

Specific risk=risk associated with the individual.

For example, in a medical condition such as breast cancer, the systematic risk is composed of the inherent risk of that disease in the form of aggressiveness to disseminate, its resistance to therapeutics, etc. The macro factors are external factors such as the current state of therapeutics, diagnostics, etc. The specific risks may include the patient's age, co-morbidities, weight, smoking status, etc. In another example, in a certain activity such as mountain climbing, the systematic risk is composed of the inherent risk of that sport (i.e., freezing, falling, etc. to death) and macro factors (i.e., advance climbing boots, GPS, etc.). The specific risk may include the climber's physical capabilities, alertness the day of the climb, diet, etc.

Individuals seek to affect the outcomes of risk to maximize the benefits to them. For example, an individual who is going to mountain climb will acquire the latest technology (i.e., boots, ropes, GPS equipment, etc.) to minimize danger. When examining the specific outcome for certain activities and/or medical conditions for a group of individuals (e.g., portfolio), specific risks can be substantially diversified. As a result, when examining the relation of a certain activity or a medical condition in a portfolio of individuals, the systematic risk is the only risk that matters.

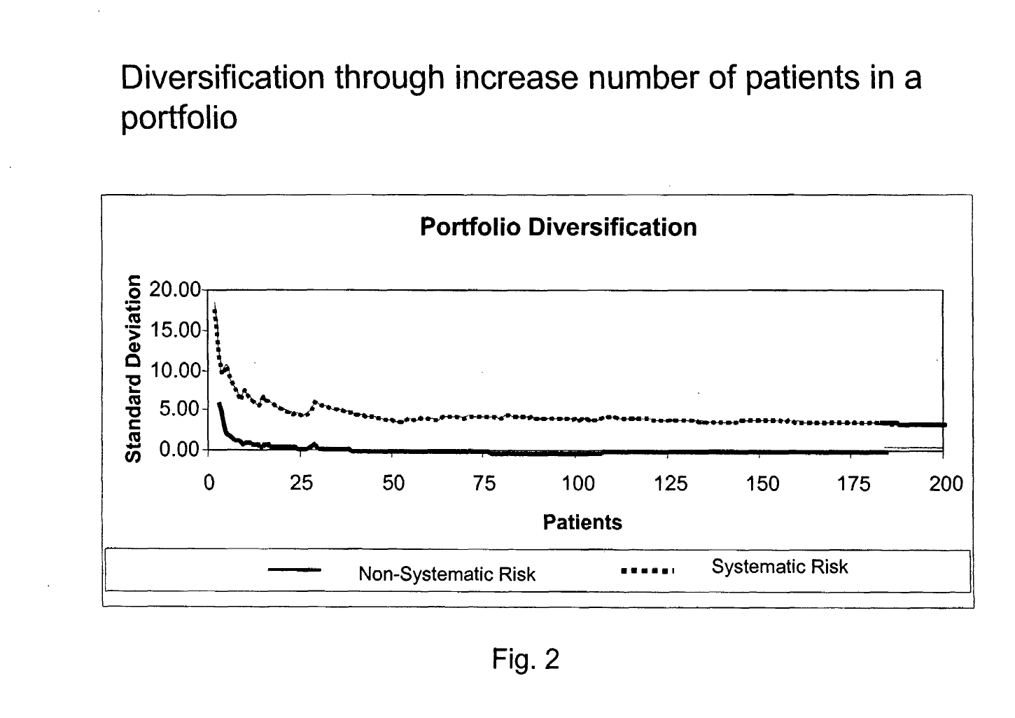

FIG. 2 illustrates the diversification of specific risk in a portfolio with increasing patient numbers. If certain activities and/or medical conditions have a mean-variance relationship with specific outcomes wherein specific risks are diversifiable, the principles of financial portfolio theory such as CAPM, APT, index model, etc. can be used to compare individuals, or a portfolio of individuals, undertaking these certain activities or those who have medical conditions. For example, comparing the performance of different cancer hospitals based on outcomes can be done in an equivalent fashion to comparing the performance of different mutual funds.

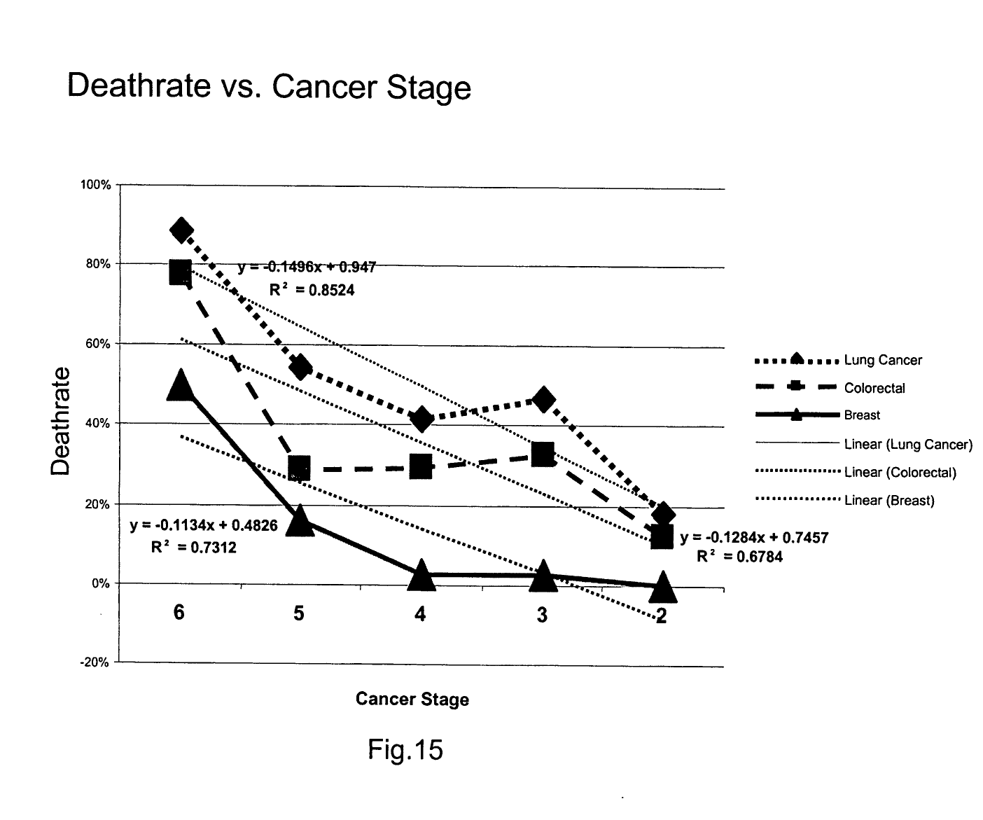

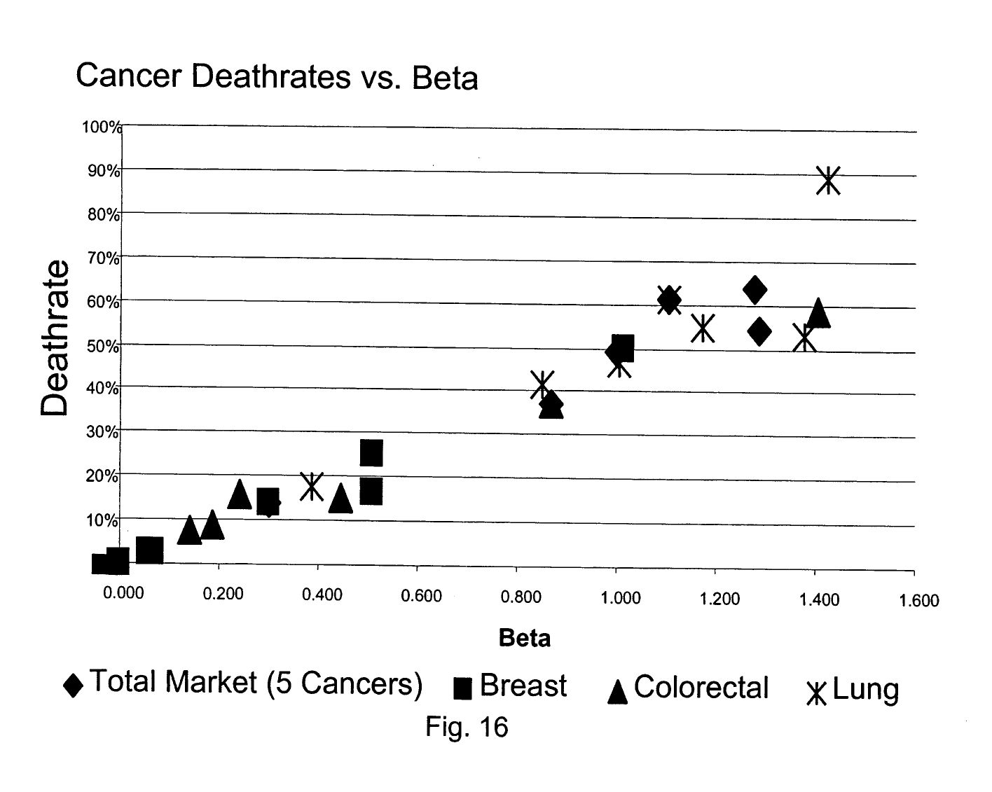

For certain activities and medical conditions, a mean-variance relationship exists. That is to say, the larger the inherent risk the greater the expected outcome. In the portfolio assembled for each cancer condition, the death rate (or other appropriate outcome) is higher with the higher stage (i.e., the larger the inherent risk the greater the expected outcome). FIG. 15 illustrates the death rate of three different cancers based on their staging. As depicted, the higher the stage for the cancer, the higher the death rate. FIG. 16 illustrates the death rate for different cancers versus the beta. As depicted, there exists a linear relationship between the risk and outcome.

Again, as discussed above, for a portfolio of individuals with certain activities and/or medical conditions where a mean-variance relationship exists with outcomes, specific risks (i.e., patient attributes) can be substantially diversified. As a result, when examining the relation of a certain activity or a medical condition in a portfolio of individuals, the systematic risk is the only risk that matters. FIG. 2 illustrates the diversification of specific risk in a portfolio with increasing patient numbers. The principles of portfolio theory can be used compare different portfolios of individuals or patients. For individuals who undertake certain activities or have medical conditions wherein the activities or medical conditions have a mean variance relationship with an outcome of interest, then comparing the individuals, or portfolio of individuals, can be accomplished using systematic risk (i.e., beta).

The present invention is directed to methods of providing risk-adjusted performance measures for a specific healthcare test, market or opportunity by evaluating patient outcomes against a real-time benchmark portfolio of patient outcomes. According to the invention, a healthcare system can be modeled as a mutual fund. Whereas a mutual fund consists of a portfolio of financial assets such as companies which are measured by their financial return, the healthcare system consists of a portfolio of patients measured by their treatment outcomes.

In the financial marketplace, directly comparing one portfolio of assets against another portfolio of assets does not give a true measure of performance. For example, comparing Mutual Fund A that has a 15% return to Mutual Fund B that has a 15% return would indicate that Mutual Fund A is performing as well as Mutual Fund B. However, this direct comparison does not take the asset profile, and therefore risk, into account. Continuing with the example, if Mutual Fund A is made up of biotechnology companies that have a high risk and Mutual Fund B is made up of utility companies with low risk, the true performance between Mutual Fund A and Mutual Fund B is different. In order to get a true performance measure, the returns for both mutual funds need to be adjusted for risk.

Similarly, in healthcare systems, directly comparing the outcome performance of one group or hospital system to another does not give a true measure of performance. While the financial markets consist of different mutual funds that have different levels of risk because of the asset profile, a healthcare system consists of different hospitals and doctor practices that similarly have different levels of risk because of their patient profile. As a result, to get a true performance measure in the healthcare system, the performance measures also need to be adjusted for risk.

The present invention is directed to systems and methods of providing risk-adjusted performance measures for a specific healthcare test, market or opportunity by evaluating patient outcomes against a real-time benchmark portfolio of patient outcomes. The risk-adjusted performance measures are based on modern financial portfolio theory, and specifically utilize methods such as capital asset pricing model (CAPM), single-index model and arbitrage pricing theory methods. In place of examining the financial returns for a portfolio of companies against a financial benchmark, the outcomes for a patient or a portfolio of patients is compared to a benchmark portfolio of patient's outcomes.

The principles described herein may be employed for evaluating the performance of different healthcare facilities having a different mix of patients. This can provide a major hospital system with a useful approach to providing real-time quality control for its remote healthcare facilities. Further, these principles may provide an insurance company that provides reimbursement services to a healthcare system with a means by which to evaluate the costs and performance of the healthcare system relative to other healthcare systems (i.e., “pay-for-performance”). Additionally, the present invention may be used in evaluating different healthcare facilities for investment purposes. Even further, the invention may be utilized in providing risk-adjusted outcome data that can be used in treatment planning and prognostic diagnostic tests. The principles set forth herein may also be employed in the development of new life-insurance products.

According to the invention, the principles of the CAPM can be used to measure performance in a healthcare setting through the proper construction of the patient portfolio. With proper construction, the patient specific risks in the patient portfolio are diversifiable. A new approach to measuring the performance of healthcare systems is feasible with the ability to diversify the specific risks of a portfolio of patients. This approach may be utilized by healthcare systems, management companies, investors and insurance companies. Furthermore, this approach provides a new method of using outcome data from a ‘patient portfolio’, wherein the patient specific risk has been diversified out for treatment planning and the development of prognostic tests (e.g. genomic based prognostic tests).

Outcomes are a quantifiable measure for a patient being treated in a healthcare system. By way of example, various outcomes may include death rate, recurrence rate, office visits, treatment costs, etc. When dealing with patients who have been diagnosed with cancer and given a specific treatment (e.g., chemotherapy, radiation therapy, surgery or combination thereof), the relevant measure of outcome may be survival and quality of life. Additional outcomes of interest may include recurrence rate, tumor shrinkage and the like. Survival data (i.e., death rate) is a good measure of outcome. Typically, survival data measures the utility of a specific treatment. Survival data is often used to compare the survival of patients with a specific treatment to those patients who get a different treatment.

Proxy outcome data can be used to provide interim ongoing outcome information. This information can be used to provide management with current information on the quality of care of its facility. Examples of proxy outcome data include days hospitalized, complications rates, and healthcare costs. An excellent proxy outcome measure that is easily obtained via computerized medical records is total days hospitalized. If the patient is diagnosed with a specific cancer and receives a specific treatment and is cured, then the days hospitalized for follow-up care over time will be minimal. However, if the treatment was not effective (or minimally effective) the days hospitalized for follow-up care would grow larger as the patient's disease progresses. As a result, the total days hospitalized following treatment of a cancer is a reasonable proxy for the effectiveness of that cancer treatment.

Proxy outcome data based on total days hospitalized can be monitored over time by periodic review of computerized hospital records. No labor-intensive surveys or chart reviews are needed. As a result, proxy outcome data can provide near real time results of the treatment effectiveness for a patient with a specific diagnosis.

For the patient portfolio, the outcomes data for each patient is recorded over time periods such as days, weeks, months, years, etc. Preferably, the initial time point in this timeline is the date of the patient's initial diagnosis. In measuring outcomes, examining the results of the patient's outcome over a number of months, if not years, is preferred. Additionally, in measuring outcomes, the time period for constructing a patient portfolio can be a “moving set time period” such as the most recent 24 months. As a result, with the passing of each new month, patients that were admitted greater than the 24 month from the current period are dropped. In this way, the outcomes for the patient portfolio can be better seen if new therapies or management systems are put into place.

A number of techniques can be used to construct the patient portfolio. In finance, a portfolio is a collection of investments held by an institution or a private individual. The assets in the portfolio could include stocks, bonds, options, warrants, gold certificates, real estate, futures contracts, production facilities, or any other item that is expected to retain its value.

In the patient portfolio, the patients can be thought as companies that make up the financial assets in a financial portfolio. In an exemplary embodiment of the invention, a “Patient Portfolio” is a patient portfolio consisting of patients treated by a healthcare institution, clinic, or a private physician (collectively “healthcare system”), and a Market Portfolio is a patient portfolio consisting of patients treated by the benchmark facility or a group of representative healthcare systems of facilities.

A company portfolio can include companies from a single industry or different industries (i.e., high technology companies, utilities, consumer companies, etc.). Likewise, a patient portfolio can include patients with a single diseases or different primary diseases. For example, in a cancer healthcare system, a patient portfolio may consist of groups of patients with a single cancer at different stages (i.e., Stage 3 breast cancer, Stage 4 breast cancer, Stage 5 breast cancer, etc.) or different primary cancers (i.e., brain & spine cancer, breast cancer, colorectal cancer, leukemia and lung cancer).

The size of the patient portfolio can range from a group greater than 1, but preferably at least 20 and more preferably greater than 100. The size required for the patient portfolio is somewhat dependent on the outcomes to be measured. If the outcomes to be measured experience change on a daily, weekly or monthly basis (e.g. days hospitalized, clinic visits, etc.), the number of patients in the portfolio can be low. If the outcomes to be measured experience only singularity changes (i.e., death, recurrence, etc.), then the number of patients in the portfolio should be higher so that the average portfolio outcomes have meaning. For the Market Portfolio, the number of patients should be relatively large. For example, for Market Portfolio, there are at least 20 patients, preferably at least 200 patients and most preferably at least 1000 patients in the portfolio.

A study was performed examining the issue of diversifiable vs. non-diversifiable risk using the approach discussed above. The average outcome (i.e., length of stay) for a portfolio of patients with cancer over a 24-month time period was examined. Specifically, the average outcome for the patient portfolio ranging from a single patient to a portfolio containing all new portfolio patients is compared using linear regression to the average outcome of the market portfolio. Using the results from the single-index model, the systematic and nonsystematic risks for the patient portfolio were calculated.

FIG. 2 is a graph illustrating diversification through the incremental increase of patients in a portfolio. Particularly, this graph illustrates the magnitude of systematic risk versus the non-systematic risk for a portfolio of cancer patients containing ˜200 patients. In FIG. 2, the standard deviation is used in lieu of the variance. The results of this study indicate that the non-systematic risks are diversifiable to large extent for portfolios containing greater but preferably greater than 30-35 patients because the sum of the residuals, σ²(e), es zero as the number of patients in the portfolio grows, thus indicating the cation of the non-systematic risk.

In view of the above findings, it is now possible to construct patient portfolios these patient portfolios as the basis for evaluating performance between healthcare using modern financial theories such as the CAPM, the single index model, and the pricing theory. Specifically, in constructing a patient portfolio, patient specific risk has been found to be diversifiable when the patient portfolio consists of greater than 20 patients. Accordingly, patient portfolios greater than 50 are preferable.

In the healthcare system, the risk premium on individual patients' outcomes or Patient Portfolio is proportional to the risk premium on the equivalent Market Portfolio, and the beta coefficient of the patient outcome (or Patient Portfolio) relative to the Market Portfolio:

rᵢ=r_{f}+βᵢ(rₘₖₜ−r_{f})

Where,
rᵢ=Patient or Patient Portfolio expected outcome
r_{f}=Risk-free outcome
rₘ=Market Portfolio outcome
βᵢ=Beta of the patient or Patient Portfolio i

As set forth above, a “Patient Portfolio” is a patient portfolio including patients treated by a healthcare institution, clinic, or a private physician (collectively “healthcare system”), whereas a “Market Portfolio” is a patient portfolio including patients treated by the benchmark facility.

For healthcare system performance evaluation, risk-adjusted performance measures similar to the financial markets can be used such as the Sharpe's measure, Treynor's measure and Jensen's measure. The equivalent risk-adjusted healthcare performance measures are defined as follows:

Sharpe's measure: (rₚ)/σₚ

Wherein,
rₚ=Expected outcome for patient or Patient Portfolio
σₚ=Variance of Patient Portfolio

Sharpe's measure divides the average patient portfolio outcomes over the sample period by the standard deviation of patient portfolio outcomes over that period. It measures the reward to (total) volatility trade-off. The Sharpe's measure should be used when the patient portfolio outcomes represent the entire database of patient outcomes for that patient portfolio.

Treynor's measure: (rₚ)/σ_{P}

Wherein,
rₚ=Expected outcome for patient or Patient Portfolio
β_{P}=Beta of the Patient Portfolio
   Like the Sharpe's measure, the Treynor's measure gives patient portfolio outcomes over the sample period per unit of risk, but it uses systematic risk instead of total risk.

Jensen's measure: αₐ=rₚ−[βₚ(rₘ)]

Wherein,
rₚ=Expected outcome for patient or Patient Portfolio
βₚ=Beta of the Patient Portfolio
rₘ=Outcome for Market Portfolio

The Jensen's measure is the average outcomes for the patient portfolio over and above that predicted by the CAPM, given the portfolio's beta and the average market return. Jensen's measure is the portfolios alpha value.

In the above measures of portfolio performance, the risk-free outcome is not employed. In practice, an equivalent portfolio of patients that do not have the specific disease can be used as the proxy for risk-free outcome data. An exemplary approach is used in the Merrill Lynch model for security risk evaluation. In this model, the derived alpha, aᵢ, from the linear regression between the patient portfolio and the Market Portfolio includes the risk-free outcome as follows:

αᵢᵣ=aᵢ+r_{f}(1−βᵢ)

Wherein,
αᵢ=actual patient or patient portfolio's expected outcome if the Mkt Portfolio is neutral;
βᵢ=component of return due to movements in the overall market and is equivalent to the beta; and
r_{f}=risk-free outcome.

The justification for this procedure is that, on a monthly basis, r_{f}(1−βᵢ) is small and apt to be swamped by the volatility of the actual patients' outcomes. For example, if we are evaluating the outcome performance for a patient portfolio consisting of breast cancer patients and the outcomes that are being measured are total days hospitalized, the anticipated days hospitalized for a person without breast cancer during that period is very small. However, an equivalent risk-free outcome for death rate can be obtained by putting together a group of individuals that is equivalent to the Market Portfolio (“Risk-Free Portfolio). The death rate for the Risk-Free Portfolio can be obtained by examining actuary tables for the individuals that make up the portfolio.

The systems and methods of providing real-time risk-adjusted performance measures set forth herein may be employed in many areas of healthcare including without limitation, management of healthcare facilities, providing insurance reimbursement to a healthcare facility, making investment decisions in the healthcare marketplace and developing dynamic prognostic diagnostic medical tests. Discussions regarding several of the potential uses for this invention are set forth hereinbelow.

Risk-adjusted performance systems and methods disclosed in this invention allow the outcomes from different cancer clinics to be adjusted for different patient profiles at each clinic. The risk-adjustment can be done without the labor intensive and costly method of adjusting results for patient specific risks. After the outcomes have been risk-adjusted, the cancer healthcare system can determine the appropriate management practices to perform for each clinic. The management of the cancer healthcare system can now put changes in place to improve the performance of the healthcare system.

The present invention provides real-time risk-adjusted performance methods for assessing healthcare system components. By real-time, it is meant that the market portfolio changes on a periodic basis (i.e., daily, weekly, monthly, etc.) so that the risk-adjustments are timely and therefore meaningful. Since this approach is easily performed through computer databases using existing data, the assessment of the healthcare system components can be done from a computer terminal at any time. When a performance problem is identified, a more extensive audit of the problem can then take place. With this new management tool, the development of large national and international healthcare systems is now feasible.

According to further embodiments of the invention, the principles set forth herein can be utilized by healthcare facilities to evaluate performance for various aspects of medical care including, but not limited to: (i) performance between different healthcare facilities within the major medical system; (ii) performance between the major medical system or its remote healthcare facilities to other major medical system or healthcare facilities; (iii) selection of optimal treatment regimes; (iv) performance of physician, service line, and/or disease group within the healthcare system (“pay-for-performance”); (v) identification of practice patterns necessary to reduce costs and increase quality; and (vi) selection of optimal treatment regimes.

For insurance companies, evaluating healthcare facilities have traditionally been done by comparing the healthcare facilities to national norms that are relatively static. The patient make-up for the healthcare facilities is dynamic, which can lead to errors in the evaluation of the healthcare facilities. The real-time risk-adjusted performance measures of the invention allow an insurance company to assess how one healthcare facility is doing compared to others. For example, an insurance company can risk-adjust for different patient profiles to assess the billings from different healthcare facilities on a real time basis to see if the billings are in line with other healthcare facilities. The ability to compare different healthcare facilities regardless of the patient profile allows the negotiation of more informed reimbursement rates. This can result in better financial performance for the insurance company.

Furthermore, the use of the risk-adjusted method for healthcare can be used to determine the cost benefit for new treatments (e.g., new drugs, therapies, devices, etc.) and therefore whether these new treatments warrant being reimbursed. By way of example, a new biological drug for treating a specific cancer is offered at $100,000 compared to the old therapy at $20,000. The clinic using the new drug finds that patients being treated with the drug are doing well. The question is whether the new treatment has benefits to warrant the high cost and should it be reimbursed.

By employing the principles of the invention, the outcomes for the patients treated with the new biological drug can be compared to the market benchmark for patients treated with the lower cost old therapy. One outcome metric that can be employed in this assessment is the total costs of drug therapy for the total portfolio divided by surviving patients in that portfolio for each time period. If the risk-adjusted outcome data for the patients at the clinic being treated with the new drug show improvement over the current treatment at the benchmark facility, then the insurance company can implement reimbursement of the new drug. If not, then the proper level of reimbursement can be determined using this technique.

For investors, comparing different healthcare opportunities for investment is difficult due to hospital specific financial results from different patient profiles. For example, two hospital systems may be examined for takeover. Both hospital systems generate $1 billion in revenue, but it is desirable to know which hospital system offers the better investment opportunity.

According to the invention, both hospitals can be compared to a benchmark facility to provide a risk adjustment based on the patient profile for each hospital system. For example, the first hospital may have a patient profile that has a higher systematic risk (i.e., beta) than the second hospital. As a result, when the Treynor's measure for the two opportunities is compared, the second hospital system's Treynor's measure is higher and therefore offers the better investment opportunity.

In another example, an investment group is seeking to acquire a hospital system and replace the management in order to gain better value from the hospital system. Currently the hospital system has $1 billion in revenues. Using this invention, it is found that the risk-adjusted revenues given the hospital systems patient profile is $0.75 billion. However, at the same risk levels the market benchmark facility has the equivalent of $0.9 billion in revenues. Therefore the hospital system has the potential of gaining $0.15 billion in revenue if managed optimally (i.e., the hospital has a negative “alpha” of $0.15 billion). With that information, the investors believe their investment thesis is correct and make the investment into the hospital system. With a change in management, the investors believe they can bring the revenues for the healthcare system up to the risk-adjusted value of $0.9 billion. Furthermore, the investors seek other hospital systems with negative “alphas” in which to invest.

Generally, the accuracy and usefulness of prognostic diagnostic tests is limited because these tests are based on data from a defined point in time. For example, a prognostic diagnostic test may be derived from a historical database containing outcome data for a specific cancer that is five years old. If a new treatment has been introduced during the intervening five years resulting in a change in outcomes for that specific cancer, the prognostic diagnostic test may no longer be relevant. To be useful, these prognostic diagnostic tests should be constantly or periodically updated to reflect changing outcome results.

According to the invention, prognostic tests can be developed as follows. Initially, a patient portfolio is generated which includes specific genomic data and outcome data. For example, 200 breast cancer patients are analyzed for specific genomic markers. These patients are followed over time to provide meaningful outcome results. Outcomes that can be used in this case may include days hospitalized, disease recurrence and other outcomes. In the subsequent step, the outcomes for patient portfolio are compared to a benchmark portfolio to determine the betas for each time period. Coefficients may be determined by multivariate analysis using betas for the Y and Xs from the genomic values. A genomic test is used to get specific genomic values. These values are plugged into the multivariate equation above to determine the beta, which is then multiplied by an updated benchmark portfolio to determine the predicted outcome for that patient.

According to various embodiments of invention involving prognostic tests, the system can be designed to be “living”. That is to say that the benchmark portfolio is constantly updated with new patients. Accordingly, the predicted outcome is always up to date and relevant.

The present invention may be utilized to risk-adjust a portfolio using a benchmark portfolio so that the outcomes from different sources can be compared. For example, a clinical trial is being performed at three different sites. Comparing the results is labor intensive because of the normalization of patient specific risk. Utilizing this invention, the outcome data from each site can be risk-adjusted against a benchmark site so that the outcome data can be easily compared and incorporated into one large dataset.

Individuals who have been diagnosed with cancer have rarely been able to obtain life insurance (e.g., term insurance, whole life, etc.). Currently, insurance companies price the life insurance products based on the specific risks of an individual. Actuary tables based on a large historical database of death rates and individual specific risks are used by the insurance companies to price a life insurance product. Given the number of cancers and the fact that death rates for cancers are changing constantly due to new therapies, assessing the risk of death for a patient diagnosed with cancer is difficult. As a result, providing a life insurance product for patients with cancer has not been practical.

According to an embodiment of the invention, the added risk of death for an individual secondary to cancer can be defined. Specifically, the risk of death (i.e., death rate) caused from cancer can be assessed and standardized for a patient treated at any medical center as follows:

D_{c}=βᵢ(rₘₖₜ−D_{P})

Where,
D_{c}=death rate of a patient of patient with cancer
D_{P}=death rate for a matching portfolio of patients without cancer (derived from actuary tables)
rₘₖₜ=market portfolio cancer death rate
βᵢ=beta

The cancer death rate, D_{c}, is risk of death secondary to having a specific type of cancer. The cancer death risk is based on the expected outcome for an individual patient. It is proportional to the risk premium on the equivalent market portfolio of patients' outcome, Market Portfolio, and the beta coefficient for the outcomes for patients with that specific cancer relative to the market portfolio. To develop a cancer life insurance product, the insurance company needs to have a way to measure total death risk as defined as follows:

Dₜ=D_{c}+Dₛ

Wherein,
Dₜ=total death risk
D_{c}=Cancer death risk
Dₛ=Patient specific death risk

As set forth above, the patient specific death risk, Dₛ, is the risk of death for individual given specific risk factors not related to cancer. The patient specific death risk, Dₛ, is based on actuary tables developed from a large historical database of death rates for individual given specific risk factors. With the ability to calculate the total risk for a patient with cancer, insurance products such as term insurance can now be developed and introduced.

The following examples illustrate embodiments of the invention, but should not be viewed as limiting the scope of the invention.

### EXAMPLE 1

### Quality Control of a Hospital System

The following is a scenario to illustrate an embodiment of this invention. Specific names, times and other identifying information may be changed due to privacy issues.

Cancer Healthcare System is a major cancer healthcare system consisting of a large major medical center, “Center”, and a smaller clinic located in a different geographical location “Remote Clinic”. Currently, measuring performance of the Remote Clinic is done through review of the financial performance and evaluation of the quality of care at the Remote Clinic and comparing it to the performance of the Center. However, comparing the performance of the Remote Clinic to the Center is problematic because the patient profile (i.e., cancer type and stage) at the Remote Clinic is substantially different than the patient profile at the Center. As a result, comparison of the performance of the Remote Clinic to the Center is difficult.

Currently, evaluation of quality of care is performed by having individuals from the Center physically go to the Remote Clinic to review the patient records to determine if the Remote Clinic is following practices and protocols instituted by the Center. Up until now, the Remote Clinic was deemed to be performing well if practices and protocols were being followed with little variance. However, management is concerned with the current approach to evaluating the quality of care at the Remote Clinic because of the high labor costs and timeliness in obtaining the quality control information. Additionally, management is concerned that its future plans to expand the Cancer Healthcare System with additional cancer centers will be limited because the current approach to evaluating of quality of care is not easily scalable. Finally, the management is concerned that the current approach to evaluate the quality of care does not provide a real measure of the effectiveness of treatment for the patients.

Accordingly, the management of the Center sought a method to measure and compare Remote Clinics to the Center. Additionally, the management of the Center sought a method that could standardize or “risk-adjust” the results based on the patient profile. Moreover, the management of the Center sought a method that could provide a risk-adjusted method of evaluating performance of the Remote Clinic based on patient outcomes. The systems and methods of this invention provide a solution for the management of the Center.

Continuing with the above scenario, the management of the Center put into place a method of the invention as follows. The initial step involved establishing the outcomes to be measured. In particular, the management of the Center felt that they were interested in measuring two specific patient outcomes for the evaluation of Remote Clinics, specifically, (1) Days Hospitalized and (2) Death rate. Days Hospitalized was defined as the accumulated number of days the patient was hospitalized from the patient's primary diagnosis at that facility, and in the case of cancer, the primary diagnosis and stage of the cancer. Death rate was defined as the survival time for the patient from the patient's primary diagnosis. Of course, as would be appreciated by those of ordinary skill in the art, other outcomes could have been selected by management including treatment costs, disease recurrence, etc., without departing from the scope of this example. The outcome information can be obtained from databases in the Center and Remote Clinics (e.g., the billing database).

The next step involved establishing the Market Portfolio and Patient Portfolio. After the appropriate outcomes were selected, the management of the Center established a portfolio of patients to act as the Market Portfolio. For this scenario the management team established the Market Portfolio based on the patients seen at the Center. Alternatively the management team could have used a Market Portfolio established by another healthcare center. In addition to establishing the Market Portfolio, the management team established a similar portfolio of patients for the Remote Clinic to act as the Patient Portfolio. This portfolio is established in the same way as the Market Portfolio.

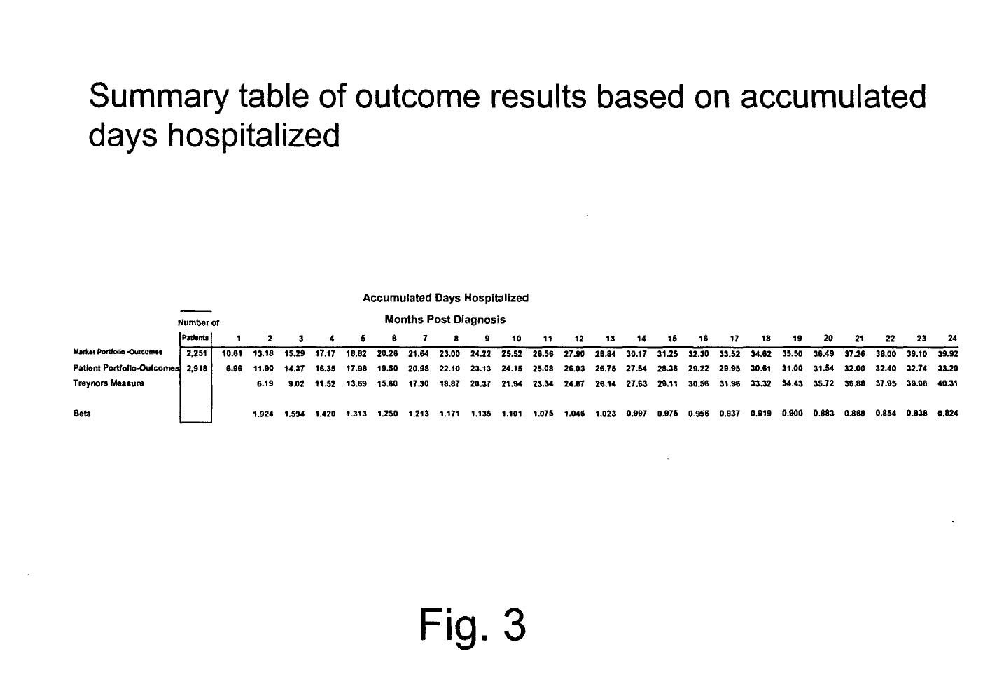

FIG. 3 is a table that provides a summary of outcome results for accumulated days hospitalized for both the Center (i.e., Market Portfolio) and the Remote Clinic (i.e., Patient Portfolio). It is constructed with over 2,200 and 2,900 patients, respectively, with the patient profile consisting of five different cancers at different proportions. The specific outcome measure for each period is:

Outcome (Days Hospitalized)=Σ(Days Hospitalized)/(Total Surviving Patients)

The time periods are months from primary diagnosis. The summary table shows the average accumulated days hospitalized for all cancers for each period from the date of diagnosis.

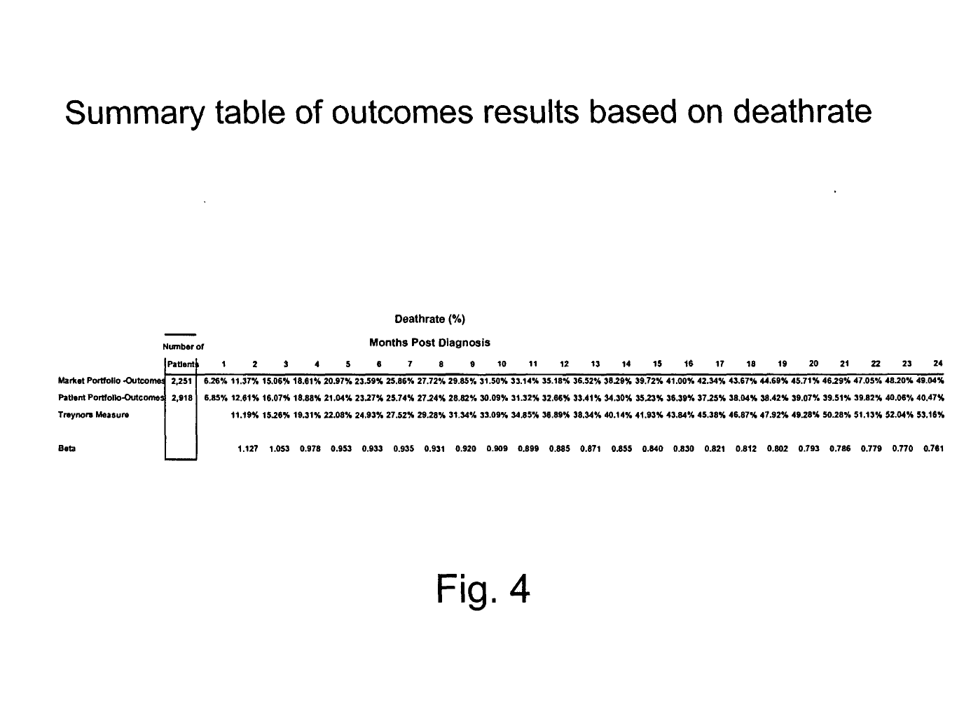

FIG. 4 is a table that provides a summary of outcome results for death rate for the Center and Remote Clinic. The summary table indicates the death rate for all cancers for each period. Similar to FIG. 3, this table is constructed with over 2,200 and 2,900 patients, respectively, with five different cancers. The time periods are months from primary diagnosis, and the specific outcome measure for each period is:

Outcome (Death rate)=Σ(Patient deaths)/(Total Patients)

After the Market Portfolio and the Patient Portfolio have been established, the performance between the Remote Clinic and the Center was compared by performing linear regression to derive the beta between the Patient Portfolio and the Market Portfolio for the outcomes for each time period.

To derive the beta at each time point, linear regression was performed on all the data between the first time period (e.g., date of diagnosis) and the time period of interest. For example, for the beta at time period 6, the linear regression was performed between the Patient Portfolio outcomes and the Market Portfolio outcomes for time period 0 (i.e., the first time period) through time period 6. Likewise, to derive the beta at time period 12, the linear regression was performed between the Patient Portfolio outcome and the Market Portfolio outcome for time period 0 through time period 12. Of course, when performing the linear regression between the two portfolios, comparisons can be made for any given time period (e.g., time period 6 through time period 12) or as a moving time frame (e.g., the last 12 time periods). For this invention, the preferred linear regression is performed between the time of diagnosis (time period 0) and the time period of interest.

The next step involved healthcare system performance evaluation. After the betas were derived using linear regression, the risk-adjusted performance measures for the Remote Clinic (such as the Sharpe's measure, Treynor's measure, Jensen's measure, etc.) were calculated. In the instant case, the preferred risk-adjusted performance measure is the Treynor's measure:

Treynor=(Oₚ)/βₚ

Wherein,
Oₚ the Remote Clinic outcome (i.e., portfolio outcome) for time period (p), and
βₚ (i.e., portfolio beta) is the derived beta for time period (p).

The Treynor's measure yields Patient Portfolio outcomes over the sample period per unit of systematic risk (i.e., beta) (versus total risk—systematic risk plus specific risk). For a portfolio with greater than 20-30 patients, the patient specific risks typically reach maximum diversification.

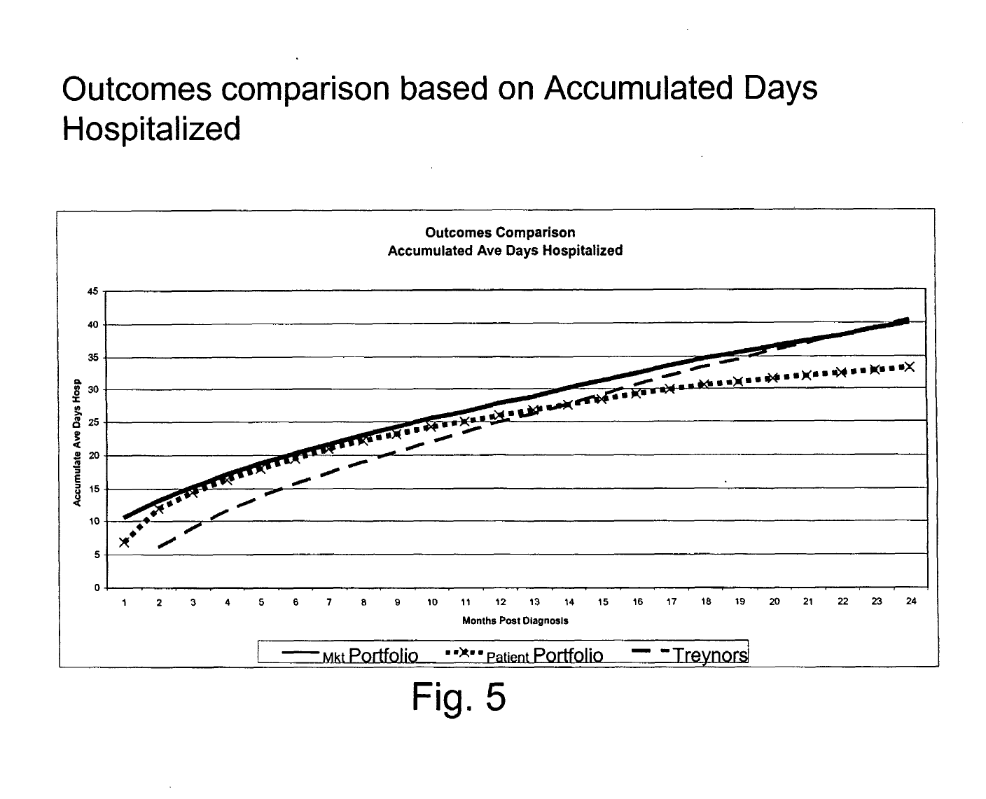

The performance between the Remote Clinic and the Center in terms of days hospitalized over a 24 month period for all five cancers is illustrated in FIG. 5. More particularly, this figure depicts the outcomes and risk-adjusted outcomes for the Remote Clinic compared to the outcomes for the Center. As illustrated in FIG. 5, after month 12, it appears that the Remote Clinic's performance is substantially better than the Center. However, when the Remote Clinic's outcomes are risk-adjusted using the Treynor's measure, the performance for the Remote Clinic is poorer than the original data indicated.

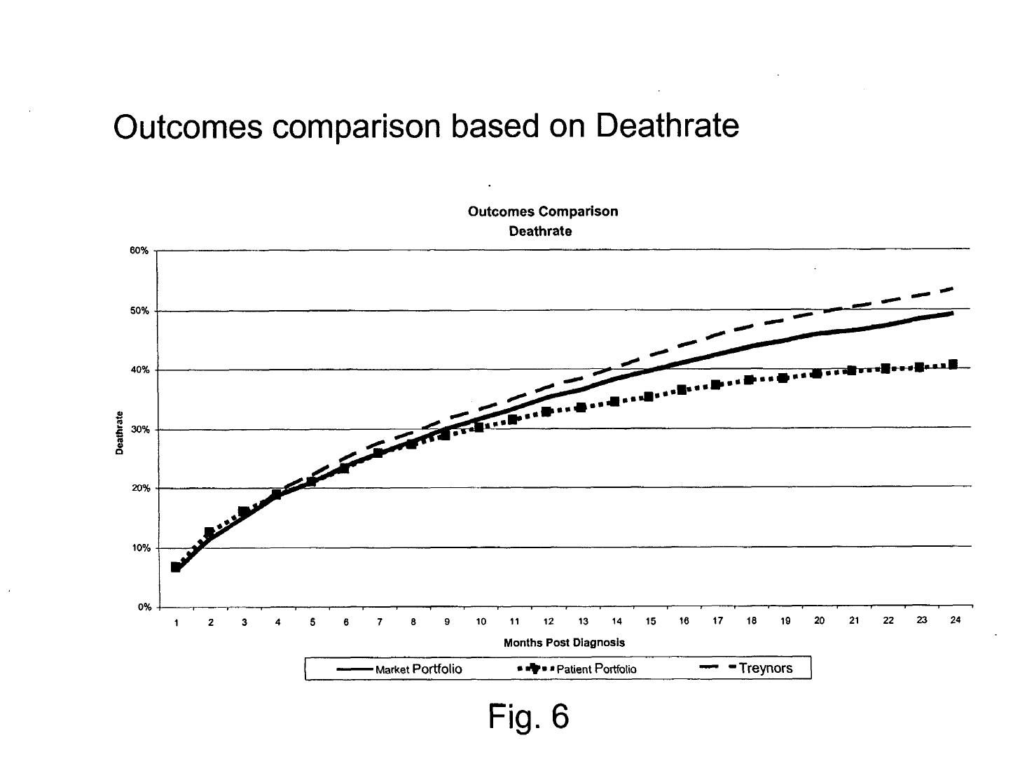

The performance between the Remote Clinic and the Center in terms of death rate over a 24 month period for all five cancers is depicted in FIG. 6. Specifically, this figure illustrates the outcomes and risk-adjusted outcomes for the Remote Clinic compared to the outcomes for the Center. As illustrated in FIG. 6, after month 12, it appears that the Remote Clinic's performance is substantially better than the Center. However, when the Remote Clinic's outcomes are risk-adjusted using the Treynor's measure, the performance for the Remote Clinic is poorer than the original data indicated.

Based on the performance measures using the methods of this invention, the Center's management had a clearer view of the performance of the Remote Clinic and could now make management decisions based on the risk-adjusted data

### EXAMPLE 2

### Breast Cancer Treatment Performance

In the second example, the management from the Center is interested in how well the Remote Clinic is performing in terms of treatment for breast cancer. Specifically, the management from the Center is interested in comparing the breast cancer outcome, in terms of death rate, between the Remote Clinic and the Center.

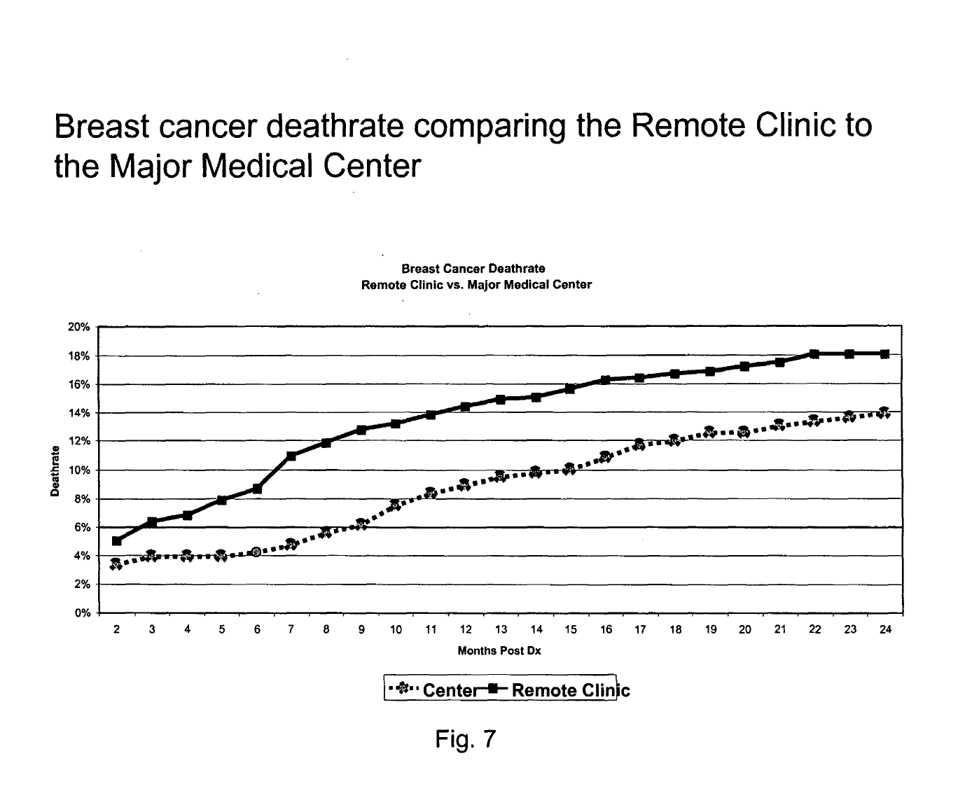

FIG. 7 is a graph illustrating the breast cancer death rate between the Remote Clinic and the Major Medical Center over a period of 24 months post diagnosis of the patient's cancer. As depicted in FIG. 7, the Remote Clinic appears to have significantly poorer performance (i.e., higher death rate) in treating breast cancer than the Center. The Center's management is concerned that the physicians at the Remote Clinic may not be following the established guidelines or protocols established at the Center for the treatment of breast cancer. One issue that was brought to the attention of the Center's management is that the Remote Clinic is located in a region where patients do not regularly visit the doctor for routine exams. As a result, it was believed that the patient population who go to the Remote Center typically are first seen when their breast cancers were more advanced.

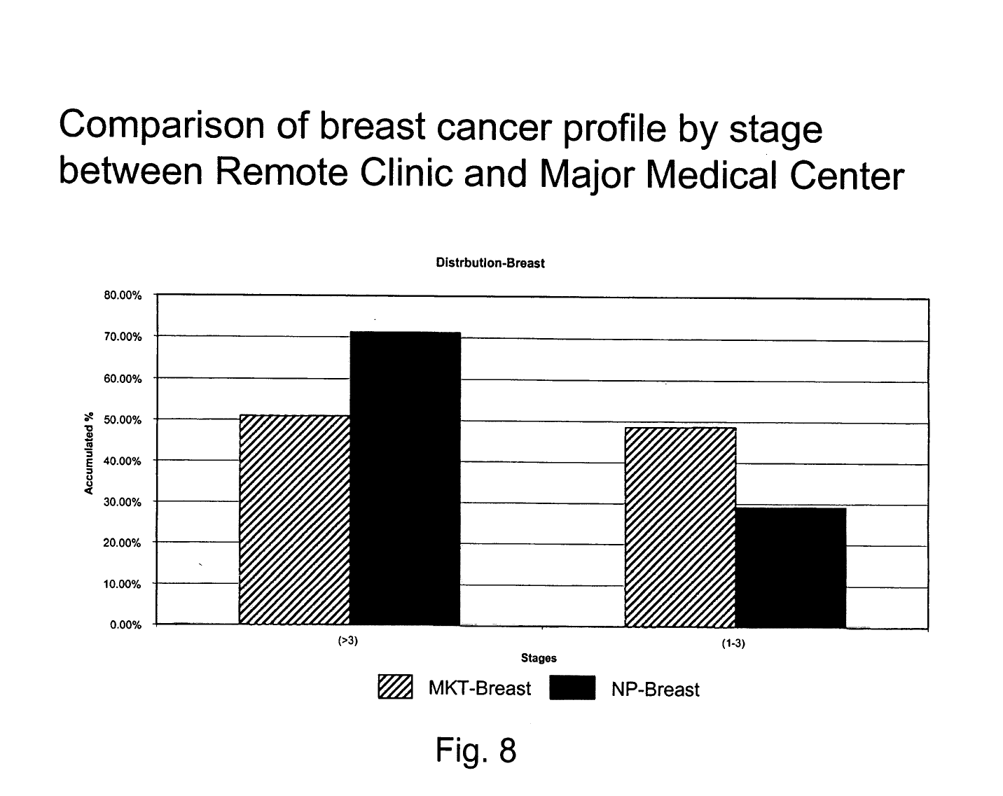

FIG. 8 is a graph comparing the profile of breast cancer patients by stage treated at both the Remote Clinic and Center. As illustrated in this figure, the patients seen at this major medical center typically have less aggressive cancer (i.e., earlier stage cancers) than the Remote Clinic. For example, 48% of the breast cancer patients seen at the Center were stage 1-3 compared to only 28% of the breast cancer patients seen at the Remote Clinic. Given this information, the management of the Center employed the systems and methods of this invention to compare the treatment of breast cancer patients at the Remote Clinic with the Center. The results from the Remote Clinic were adjusted for risk to reflect the fact that the Remote Clinic sees patients with more aggressive cancer. Specifically, the breast cancer death rate was compared between the Remote Clinic and the Center to derive a beta for each time period. This beta was then used to calculate the Treynor's measure for death rate of the breast cancer patients at the Remote Clinic.

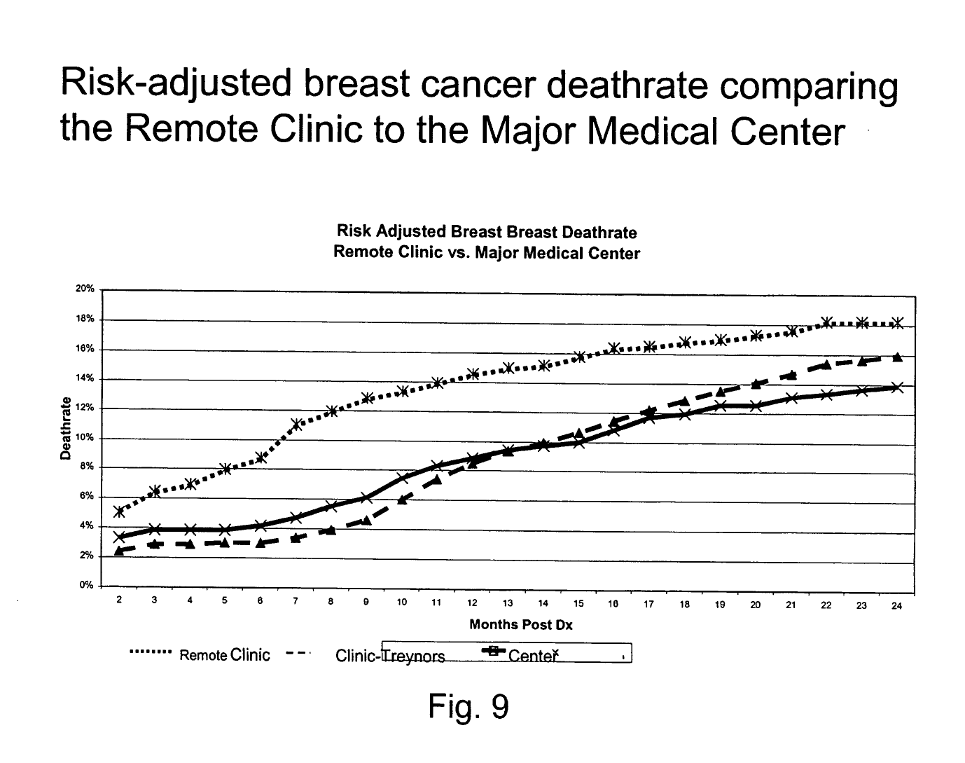

FIG. 9 is a graph similar to that of FIG. 7 with the addition of the breast cancer risk-adjusted death rate (i.e., Treynor's measure) for the Remote Clinic. After risk-adjusting the outcomes for the breast cancer, the performance of the Remote Clinic in the first 14 months was as good, if not better, than the Center as reflected by lower death rates. After month 14, the performance of the Remote Clinic was poorer than the Center. However, the performance was not nearly as poor as it appeared to be prior to risk-adjusting the outcomes using the methods of this invention. By employing the systems and methods of this invention, management quickly determined that the performance at the Remote Clinic was adequate in the treatment of breast cancer. An examination of long-term follow-up care was planned to see if the poorer performance could be explained.

### EXAMPLE 3

### Pay-for-Performance

In addition to the Remote Clinic, the Center is associated with a small hospital (“MiniMed”) that has a number of physician groups including ten physician oncology groups (MD Group 1, MD Group 2, etc.). The management of the Center is interested in renegotiating the pay package it provides each of these community oncology groups based on performance. Initially, the Center's management based performance on the costs per patient seen by the different physician oncology groups at MiniMed.

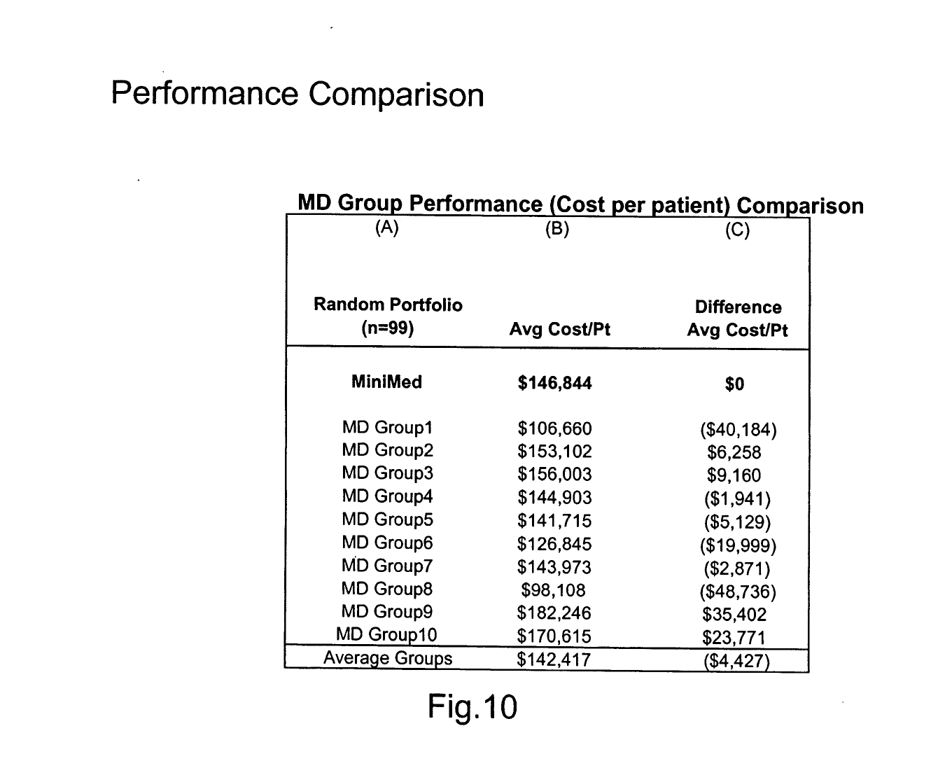

FIG. 10 is a table that provides the performance of the ten physician oncology groups employed at MiniMed (column B). The differences between the performance of the ten physician oncology groups and the performance of MiniMed are shown in column C of the table. Based on this comparison, the performance of the 10 oncology physician groups at MiniMed had an averaged total treatment costs per patient of $142,417, which was better than MiniMed's average total treatment costs per patient of $146,844. Within the oncology physician groups, MD Group 9 appeared to perform the poorest with total average treatment cost being higher then MiniMed by $35,402. On the other hand, MD Group 8 appeared to perform the best with total average treatment costs per patient being lower than MiniMed by $48,736.

After this initial analysis was completed, the Center's management had a concern that only looking at average treatment costs per patient may not reflect true performance. The Center's management understood that the costs of treating patients with more aggressive disease is also higher than treating patients with less aggressive disease (i.e., treating patients who have stage 4 breast cancers is more expensive than treating patients with stage 1 breast cancer). Consequently, if MiniMed or any of the MD Groups were treating patients with more aggressive disease, then its average treatment costs should be higher. As a result, looking at performance based on average treatment costs per patient did not reflect the added risk of the patient population that was treated (i.e., patient profile).

Given the concern with using treatment costs per patient as a performance measure, the management used the methods of this invention to derive a more useful performance measure—risk-adjusted treatment costs per patient. The Center's management team derived a beta for MiniMed and each of the 10 MD Groups based on patient outcomes in terms of death rate compared to the outcomes at the Center (i.e. Market Portfolio), using methods described in Example 1. The derived beta provided a systematic risk factor that accounted for MiniMed and each of the 10 MD Groups' patient profile as determined by outcomes in comparison to MajorMed's patient profile (i.e., Market Portfolio). This derived beta was used to risk-adjusted the costs of treatment by dividing the performance measure by beta to provide the following equation:

Risk-Adjusted Performance=Performance/Beta

Wherein the Performance Measure for this scenario is average total treatment costs per patient.

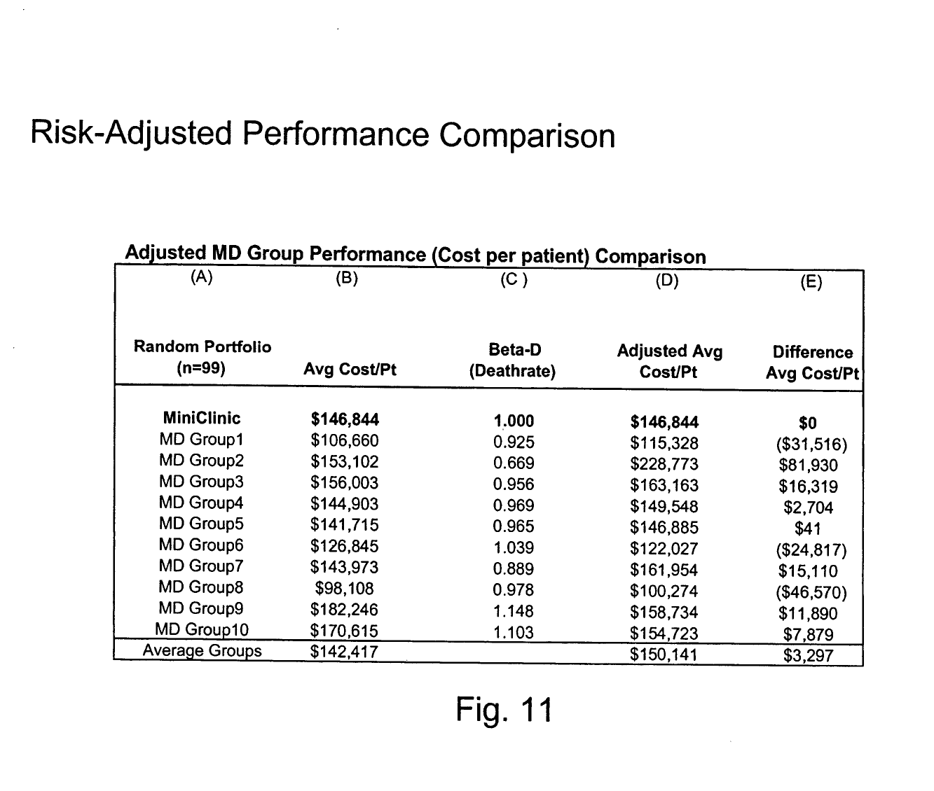

FIG. 11 is a table that depicts the risk-adjusted performance of the 10 MD Oncology Groups. In this figure, MiniMed was used as the market portfolio to derived the betas for the 10 MD Oncology Groups. The risk-adjustment, beta, for the ten MD Oncology Groups is shown in column C. The risk-adjusted performance is measured in terms of average total treatment costs per patient divided by the beta and shown in column D. The differences, risk-adjusted for performance between the physician oncology groups and MiniMed, are shown in column E of the table.

Based on this risk-adjusted comparison, the average performance of the 10 oncology physician groups' risk-adjusted total treatment costs per patient was $150,141 which is poorer than MiniMed's average total treatment costs per patient of $146,844. Within the oncology physician groups, MD Group 2 appeared to perform the poorest with total average treatment costs higher than MiniMed by $81,930. Of special interest to the Center's Management was the performance of MD Group 9. In the first performance comparison, MD Group 9 appeared to perform poorly with total average treatment costs higher than MiniMed by $35,402. However, when the patient profile was considered (i.e., risk-adjusted), MD Group 9's performance improved with total average treatment costs per patient being higher than MiniMed by only 11,890.

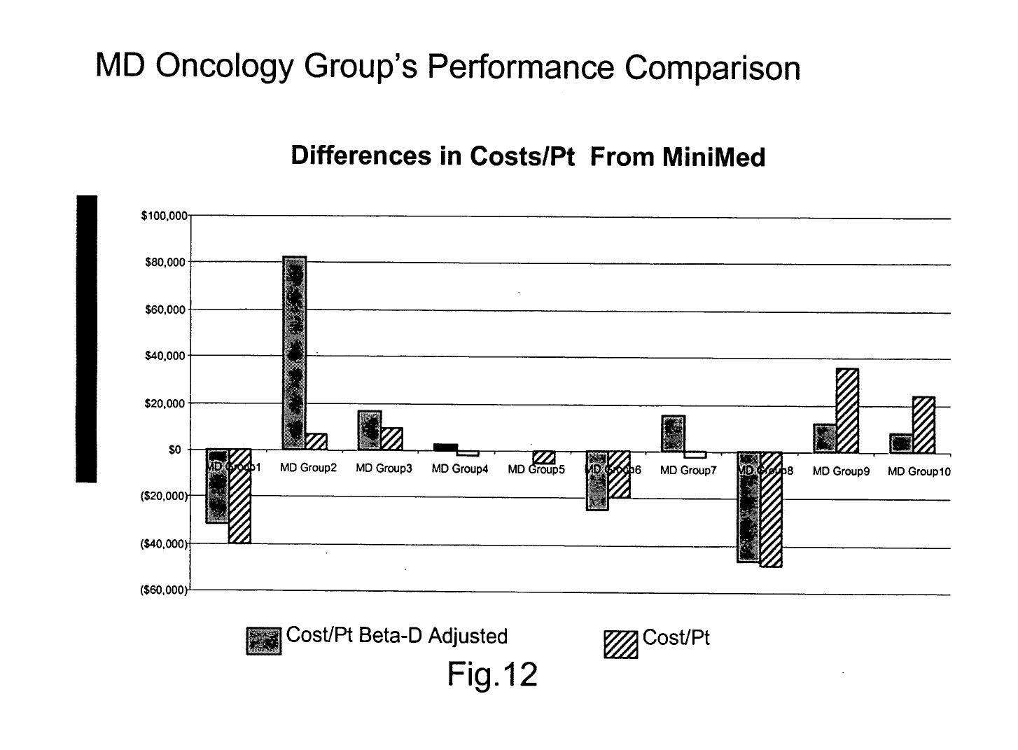

FIG. 12 provides a graphical presentation comparing the performance of the MD Oncology groups using unadjusted and risk-adjusted performance measures (costs per patient). As depicted, all groups are affected by risk-adjustment with some groups affected more than others (e.g., MD Oncology Group 2 vs. MD Oncology Group 4). As a result of this study, the management used risk-adjusted costs as the basis for performance measure between the oncology groups for renegotiating the pay packages.

### EXAMPLE 4

### Prognostic Test

The accuracy and usefulness of prognostic tests are limited because they are based on data from a defined point in time. For example, a prognostic diagnostic test may be derived from a historical database containing outcome data for a specific cancer that is five years old. If a new treatment has been introduced during the intervening five years resulting in a change in outcomes for that specific cancer, the prognostic diagnostic test may no longer be relevant. A problem with using data collected from a specific time period is that during the intervening time from when the data is collected, changes in the treatment of the disease may occur that makes the past data no longer useful for the prognosis of outcome for the specific disease. In the example above, if a new treatment was introduced during the intervening five years resulting in reduction in half of the death rate for that specific cancer, the prognostic diagnostic test may no longer be relevant because it is based on the older data. To be useful, these prognostic diagnostic tests need to be constantly or periodically updated to reflect changing outcome results.

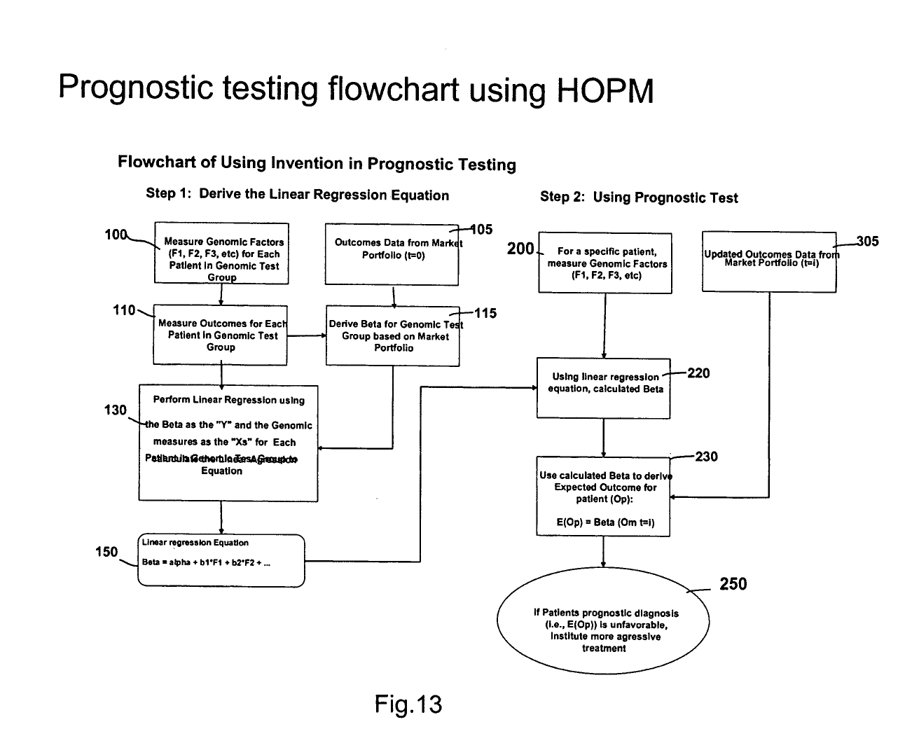

FIG. 13 depicts a prognostic testing flowchart using HOPM (Healthcare Outcomes Performance Measurements) in accordance with an embodiment of the present invention. The general concept involves deriving a linear regression equation based on genomic factors that provides an expected “beta”. This beta can be used to calculate the expected outcome from the benchmark portfolio. In this flowchart, it is assumed that the prognostic tests are genomic tests that examine the levels of three genomic factors (e.g., F1, F2 and F3). In step 100, a group of patients with a specific cancer have their tumors tested for the levels of genomic factors F1, F2 and F3. This test group of patients (“Genomic Test Group”) is followed for a period of time to determine the outcomes for each patient in step 110. Outcomes data from the Market Portfolio (t=0) is provided in step 120.

In step 130, the beta is calculated for each time period by comparing the outcomes results for each patient in the Genomic Test Group against the Market Portfolio for that time period of interest. Step 140 involves performing linear regression on the betas and the genomic factors, F1, F2, and F3. Linear regression coefficients are derived for the linear regression equation 150 that can be used in prognostic tests. To use linear regression equation 150, a patient that has been diagnosed with the relevant cancer has a genomic test performed to measure the levels of genomic factor F1, F2 and F3 (step 200). These genomic factors are then plugged into the derived linear regression equation 150 to determine a corresponding beta (step 210).

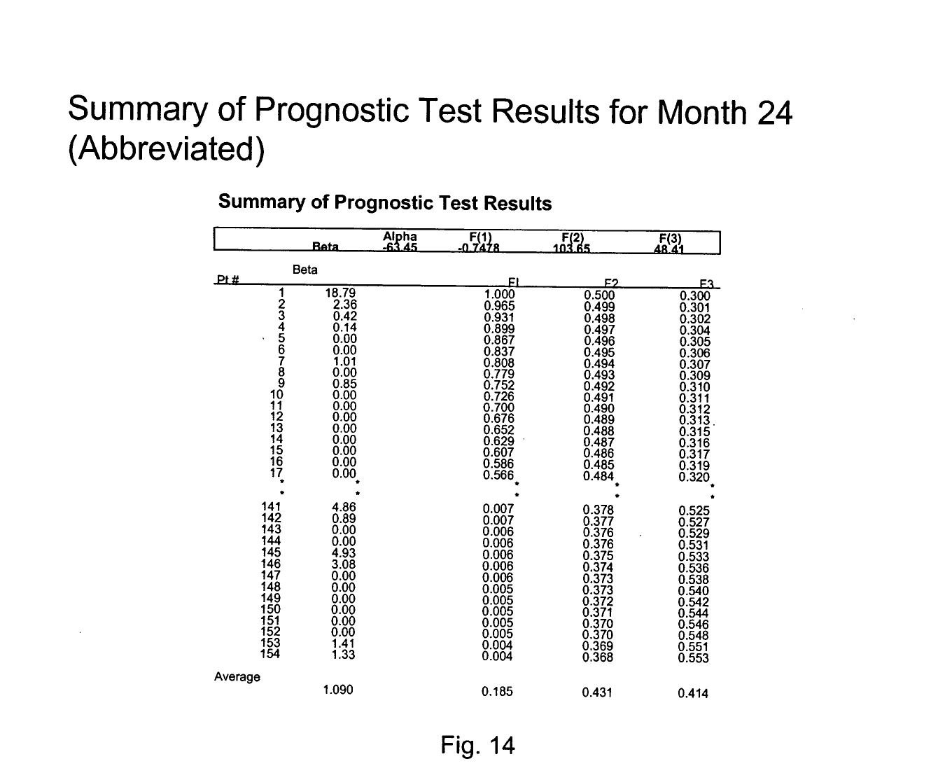

FIG. 14 is a summary table of the prognostic tests results, outcomes (i.e., accumulated days hospitalized) for a genomic test group (n=154) as well as the results of the genomic testing (i.e., F1, F2, F3). In addition, FIG. 14 illustrates the linear regression equation with the derived coefficients:

Beta=−0.7478*(F1)+103.65*(F2)+48.1*(F3)−63.45

To use this prognostic test, the results from a patient's genomic test F1, F2, F3 can be plugged into this linear regression equation to calculate the expected beta. The patient had measured genomic factors F1=0.726, F2=0.491 and F3=0.311 giving a calculated value for beta of 1.962. Updated outcomes data from the Market Portfolio (t=i) is provided in step 220. For example, if the Market Portfolio's outcomes change significantly because of a new treatment, the prognostic test using a calculated Beta will reflect these changes. In step 230, this beta is used to calculate the expected outcome for that patient (e.g., E(Op)) using the following equation:

E(Op)=Beta*Om (t=i)

Where Om (t=i) is the specific outcome measured from the Market Portfolio at a specific time i.

At month 24, the Market Portfolio had average days of hospitalization of 8.94 days. Thus, the E(Op) is 17.54 days given the patients prognostic test results. Given this high anticipated days hospitalization, the physician treating this patient determines the prognosis is poor and aggressive therapy is warranted (step 240). Because the results are continually updated, the calculated prognosis for the patient is much improved. For example, given a new therapy for the treatment of the specific cancer, at month 24 the Market Portfolio had an average days hospitalization of 4.47. Thus, the E(Op) is calculated to be 8.77 days hospitalized.

By contrast, using a prognostic test based on prior art approaches would have given the same prognosis for this patient despite the change in the overall survival of patients having this specific cancer. Only by performing new clinical trials to derive new coefficients reflecting the new outcomes can the current prognostic tests keep current. Of course, this is both costly and time consuming. The systems and methods of the invention solve this problem to enable prognostic tests that keep current with changes in outcomes. As a result, a prognostic test based on this invention can be adjusted in real-time making the test robust overtime.

### Validation Test of HOPM

The HOPM relationship is denoted by the following equation:

E(Oᵢ)=O_{f}+βi(Oₘ−O_{f})

Wherein β is the systematic risk for portfolio or individual i and is derived from the slope coefficient in a linear regression model of the individual or portfolio outcomes versus the market index (Diagonal model).

The risk of any individual outcome or portfolio outcome is measured relative to the total riskiness of the market portfolio. For HOPM, the risk-free outcome is usually zero. For example, if the outcome measure is death rate for cancer, the risk-free outcome would be no cancer and therefore no death rate from cancer. Thus the equation for HOPM relationship simplifies to the following:

E(Oᵢ)=βᵢ(Oₘ) (1)

Just as with CAPM, to test the validity of HOPM, a cross-sectional regression is performed to determine the coefficients for the following equation:

Oᵢ=αₒ+α₁(βᵢ) (2)

First, the βᵢ is derived from the regression (equation 1) of a time series of individual outcomes. More preferably, βᵢ is obtained from a time series of portfolio outcomes versus the market portfolio which is used as a proxy for the market index. Second, the derived βᵢ is used in a second-pass regression to derive the coefficients of equation 1. The estimated coefficient α₁ obtained from the second-stage regression is then compared to Oₘ for the time period under consideration. For HOPM to be validated using this approach, α₁ should be substantially equivalent to Oₘ. Furthermore, the coefficient αₒ is expected to be 0, or close to 0, since expected outcomes should not be affected by nonsystematic risk. For CAPM, this is not the case. The coefficients derived from the second pass regression are substantially different from the value (Rₘ−R_{f}). This finding has led to the generation of numerous academic papers explaining why the results are inconsistent with CAPM.

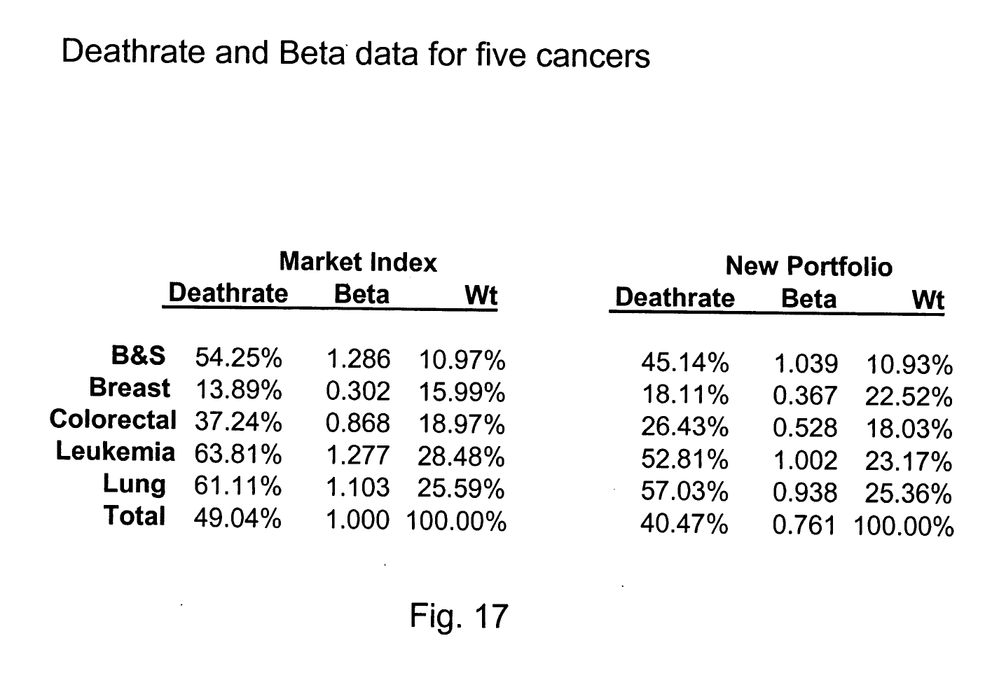

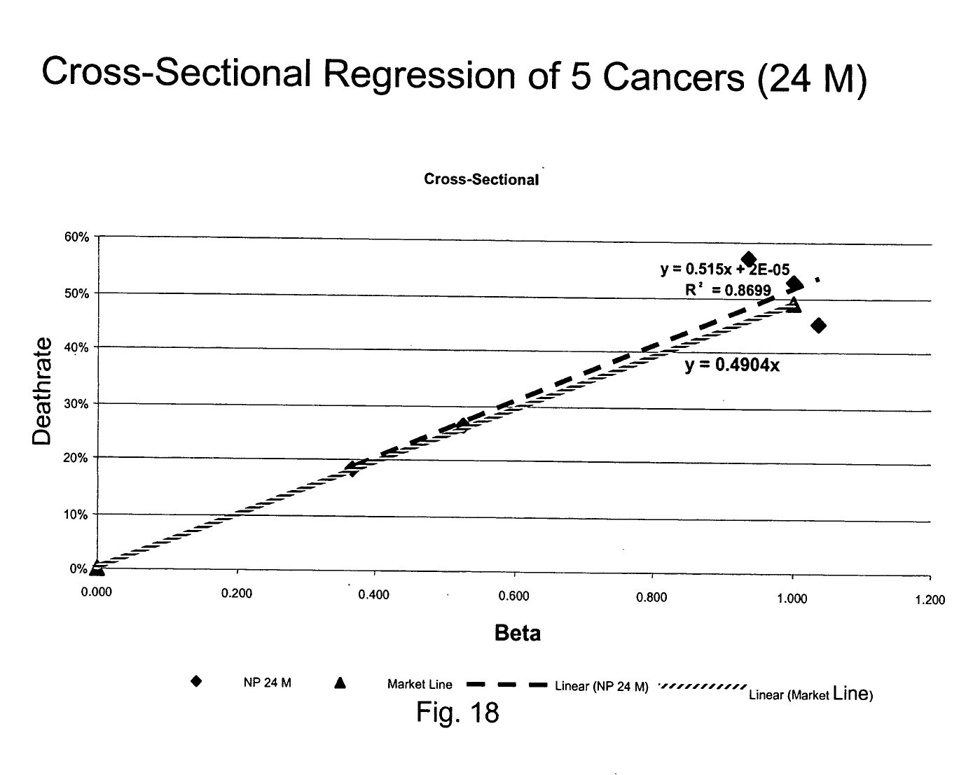

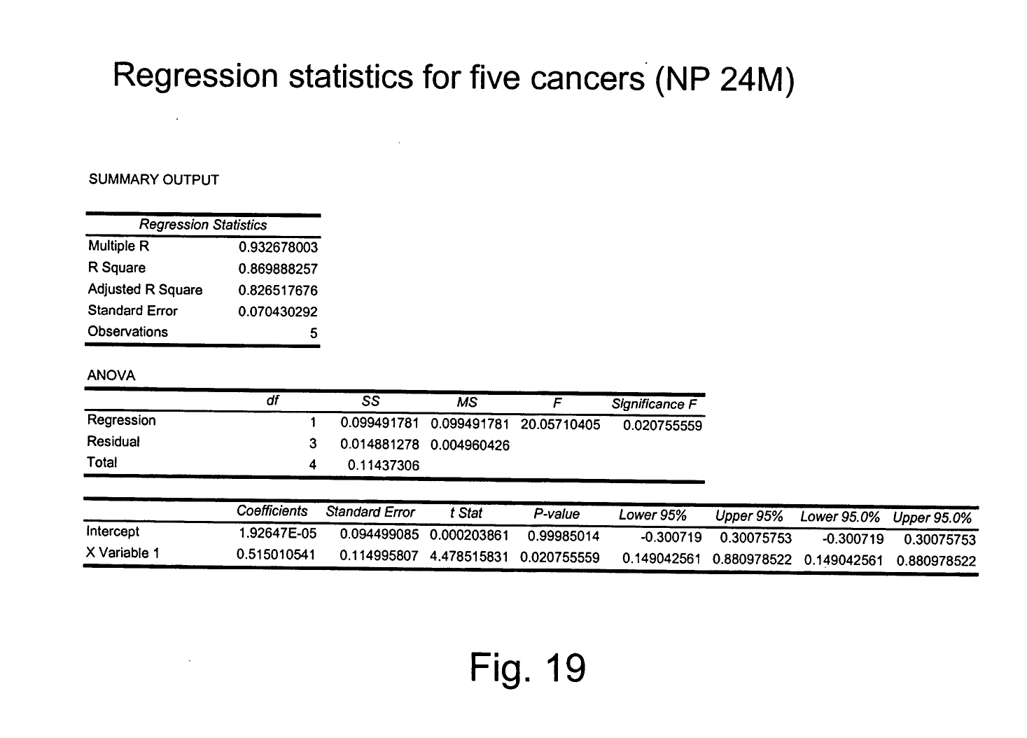

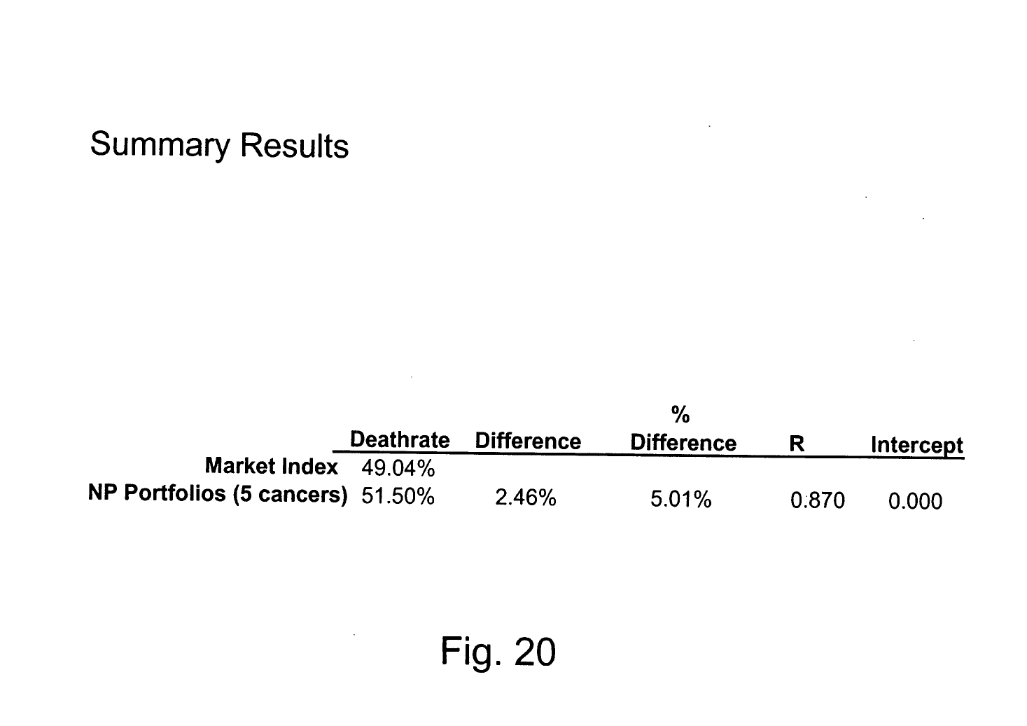

To test HOPM, the Beta for death rate at month 24 (post diagnosis) of 5 different cancers portfolios (brain & spine, breast, colorectal, leukemia and lung) were generated using regression against the total market index. The resulting Betas are illustrated in FIG. 17. These Betas and their corresponding outcomes were used in a second-pass linear regression. The graphical representations, as well as the results of the regression, are depicted in FIG. 18. A detailed summary output of the linear regression for the NP cancer portfolios is illustrated in FIG. 19, while the results of the cross-sectional test are illustrated in FIG. 20. The α₁ for the NP Portfolios (5 cancers) is 51.5% respectively compared to the Market index 24 month death rate of 49.04%. The a₀ for the NP Portfolios (5 cancers) is 0.00%. The results of this cross-sectional test support the validity of HOPM.

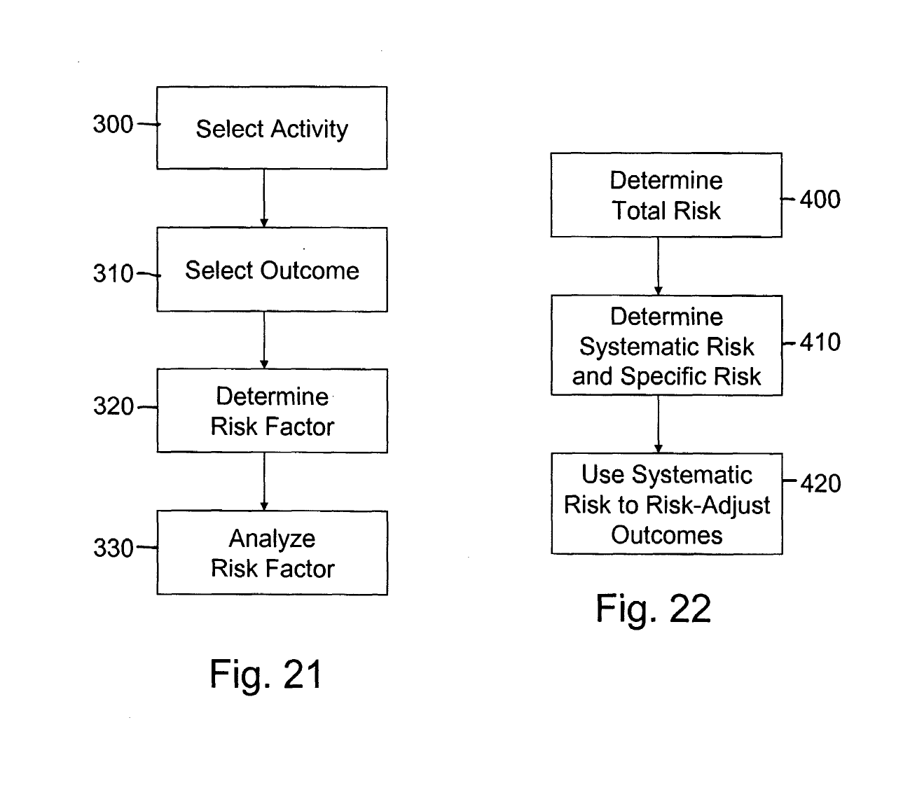

In accordance with the principles of the invention, an exemplary method for risk-adjusted performance is illustrated in FIG. 21. Particularly, this exemplary method includes the steps of selecting an activity (step 300), selecting an outcome to use as a performance measure (step 310), determining a risk factor that has an association with the outcome (step 320), and analyzing the determined risk factor to use in risk-adjusting the outcome (step 330).

An exemplary method for determining risk factors for an outcome of an activity is illustrated in FIG. 22. Specifically, the method includes the steps of determining total risk (step 400), determining systematic risk and specific risk (step 410), and using systematic risk to risk-adjust outcomes (step 420). In this exemplary embodiment of the present invention, a measure of total risk for a patient having a certain medical condition is segmented into the systematic risk of a particular outcome for the medical condition and the patient's specific risk factors. Systematic risk may comprise an inherent risk associated with the occurrence of a condition, along with external “macro factors.”

Inherent risk factors for a condition may generally include the risk of one or more outcomes occurring that are associated with a specific medical condition. Macro factors may include any suitable external factors, such as the current state of therapeutic treatments, and diagnostic procedures. Specific risk factors may include any suitable conditions specific to the patient, such as age, weight, the status of other diseases, etc. Any suitable method may be used to perform a risk adjustment for an outcome, including utilizing population and/or market analysis algorithms such as a CAPM, a single index model and/or an arbitrage pricing model.

The analysis of risk factors may be performed in any manner to achieve any appropriate result. In an exemplary embodiment of the present invention, risk factors for patients in a plurality of healthcare systems may be compared in order to determine the relative performance of the plurality of healthcare systems. Any appropriate method for risk-adjusted performance evaluation may be employed, including the Sharpe's measure, Treynor's measure and/or Jensen's measure.

### Database Set-Up for HOPM

For a sample of patients that have had their first diagnosis in a given time frame to create a portfolio of patients, the selection of the specific time frame is dependent upon what time horizon the analyst wants to evaluate patients with the HOPM method. If the analyst wants to evaluate a two-year period of outcomes, then all patients in the sample need to have had their first diagnosis no sooner than two years ago. Conversely, if the analyst wants to evaluate a five-year period of outcomes, then all patients need to have had their first diagnosis no sooner than five years ago.

The number of patients in the portfolio should to be large, wherein “large” may be defined as 2,500 patients or more. Additionally, the types of patients that make up the portfolio should be diverse, wherein “diverse” may be defined as including at least five or more different disease types. In addition to disease type, the stage of the cancer should be represented also as descriptive data for each patient in the portfolio.

Once the patients have been identified, the outcome data (i.e. days hospitalized, death rate, or costs) should accompany the descriptive data for each patient. As time increments forward, the outcome data (days hospitalized) increases. This is because the outcome fields are set-up as cumulative measures. If the analyst were evaluating outcome data such as costs or cost per days hospitalized, then the same “per patient” cumulative logic would apply.

Conversely, if death rate were being evaluated as the outcome data and since death is a singular event “per patient”, then the records would only have a “1” in the time period where death had occurred on a “per patient” basis. “Per patient” is accented in the former descriptions because while the per patient record only captures a “1” if death occurs in the below table, the Average Death Rate is cumulative as time passes.

One aspect of designing the database is to “Normalize Time”. Suppose that the analyst is attempting to evaluate a 24-month post diagnosis span of time for a portfolio of patients and today is Jan. 1, 2006. Given the supposed date, the analyst could not choose a set of patients with a first diagnosis date after Dec. 31, 2003. Unless the database upon which the portfolio is created has an extremely large number of records, the analyst would probably not be able to get 2,500 patients (the recommended minimum number of patients to create a portfolio) that have a first diagnosis date on Dec. 31, 2003. As a result, the analyst would probably need to pull patients from a time range well before Dec. 31, 2003 up to that date. For example, the analyst would probably need to pull patients from Dec. 31, 2003 back one and a half years to Jun. 30, 2002 so that he or she can get at least 2,500 patients to complete the portfolio. The previous sentence assumes that the source of the market data is relatively small in scale. It is conceivable that the source is relatively large in scale and that all patients comprising the market portfolio have first diagnosis dates on Dec. 31, 2003.

However, if the analyst takes patients over the year and a half period between Jun. 30, 2002 and Dec. 31, 2003 in order to get enough patients to create a meaningful portfolio, then the analyst will need to “normalize” the time logic on the newly created database such that time is measured in months post diagnosis rather than actual calendar points in time. Accordingly, the monthly time fields in the database represent time post diagnosis as opposed to calendar time.

Thus, it is seen that methods for risk-adjusted performance analysis are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative embodiments may be implemented to achieve the desired features of the present invention. Also, a multitude of different constituent part names other than those depicted herein may be applied to the various parts of the devices. Additionally, with regard to operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

1. A method for comparing healthcare outcomes that have been risk-adjusted to a benchmark of real-time healthcare outcomes, comprising:
selecting an activity;
selecting an outcome to use as a performance measure;
determining a risk factor that has an association with the outcome; and
analyzing the determined risk factor to use in risk-adjusting the outcome.

2. The method of claim 1, wherein the healthcare outcomes are independent of patient specific risk factors.

3. The method of claim 1, further comprising determining the risk-adjusted performance measure.

4. The method of claim 3, further comprising applying the risk-adjusted performance measure determined to improve management of components of a healthcare system.

5. The method of claim 3, further comprising applying the risk-adjusted performance measure determined to evaluate performance of a healthcare system.

6. The method of claim 3, further comprising applying the risk-adjusted performance measure determined to provide life insurance products for individuals with significant illnesses.

7. The method of claim 3, further comprising applying the risk-adjusted performance measure to a make a decision on financial opportunities in healthcare.

8. The method of claim 3, further comprising applying the risk-adjusted performance measures determined for healthcare treatment planning.

9. The method of claim 3, further comprising applying the risk-adjusted performance measure to analyze pay-for-performance measures of healthcare groups and individuals.

10. The method of claim 3, further comprising applying the risk-adjusted performance measure in medical prognostic testing.

11. The method of claim 1, further comprising creating a database containing descriptive data and outcome data for the patients treated,
wherein the outcome data for the database is continually updated.

12. The method of claim 11, wherein the descriptive data of patients treated comprises data selected from the group consisting of diagnosis data, stage of diagnosis data, treatment data, and initial treatment data provided for the diagnosis.

13. The method of claim 1, wherein the performance measure is risk-adjusted based on a financial portfolio theory.

14. The method of claim 13, wherein the financial portfolio theory is selected from the group consisting of Sharpe's measure, Treynor's measure and Jensen's measure.

15. A method for determining risk factors for an outcome of an activity by comparing real-time healthcare outcomes that have been risk-adjusted to a benchmark of real-time healthcare outcomes by systematic risk, comprising:
determining total risk of the activity;
determining systematic risk and specific risk of the activity; and
using systematic risk to risk-adjust outcomes.

16. A method for providing performance measures for healthcare by comparing real-time healthcare outcomes in the healthcare market that have been risk-adjusted to a benchmark of real-time healthcare outcomes, comprising:
selecting an outcome to measure performance of the healthcare;
establishing a benchmark portfolio from a benchmark facility and a patient portfolio from a healthcare market;
performing linear regression between the outcomes from the patient portfolio and the outcomes from the benchmark portfolio;
deriving linear regression factors, alpha and beta;
calculating risk-adjusted performance measures for the outcomes for the patient portfolio from the derived linear regression factors; and
determining the calculated risk-adjusted performance measures to provide performance measures for the healthcare market.

17. A computer program stored on a computer readable medium for providing real-time risk-adjusted performance measures for healthcare, comprising:
machine readable instructions for comparing the healthcare outcome with a benchmark of real-time healthcare outcome; and
machine readable instructions for determining a risk-adjusted performance measure.

18. The computer program of claim 17, wherein the risk-adjusted performance measure is based on a model selected from the group consisting of: a CAPM, a single index model, and an arbitrage pricing model.

19. The computer program of claim 18, wherein the model is based on Sharpe's measure, Treynor's measure or Jensen's measure.

20. A computer program stored on a computer readable medium for comparing healthcare groups using risk-adjusted performance measures comprising:
machine readable instructions for selecting an outcome to measure a performance of a healthcare market;
machine readable instructions for establishing a benchmark portfolio from a benchmark facility and a patient portfolio from a healthcare group;
machine readable instructions for performing linear regression between the outcome from the patient portfolio and the outcome from the benchmark portfolio to derive linear regression factors alpha and beta;
machine readable instructions for calculating risk-adjusted performance measures for the outcomes for the patient portfolio from the linear regression factors; and
machine readable instructions for calculating risk-adjusted performance measures to compare the healthcare groups.

21. The computer program of claim 20, further comprising machine readable instructions for determining an optimal treatment for a patient.
